(19) United States
(12) Patent Application Publication
(10) Pub. No.: US 2024/0309142 A1
(43) Pub. Date: Sep. 19, 2024

(54) CAPPED BLOCK COPOLYMERS, THEIR SYNTHESIS, MANUFACTURE, AND METHODS OF USE

(71) Applicant: ECOLAB USA INC., Saint Paul, MN (US)

(72) Inventors: Victor Fuk-Pong Man, Saint Paul, MN (US); Xiaojin Harry Li, St. Paul, MN (US); Yiqing Chen, Saint Paul, MN (US); Gang Pu, Saint Paul, MN (US); Clinton Hunt, JR., Saint Paul, MN (US)

(21) Appl. No.: 18/606,280

(22) Filed: Mar. 15, 2024

Related U.S. Application Data
(60) Provisional application No. 63/490,857, filed on Mar. 17, 2023.

(51) Int. Cl. C08F 293/00

(52) U.S. Cl. CPC C08F 293/00

(57) ABSTRACT

This disclosure relates to capped block copolymers, preferably reverse block copolymers capped with a hydrophobic group. Preferred hydrophobic groups include benzyl groups and silyl groups. In a preferred embodiment, the reverse block copolymer has at least two arms, wherein each arm is capped with a hydrophobic group. The disclosure also provides for the synthesis of the capped block copolymers as well as methods of using the capped block copolymers for defoaming and antifoaming applications.

### CROSS REFERENCE TO RELATED APPLICATIONS

This application claims priority under 35 U.S.C. § 119 to provisional patent application U.S. Ser. No. 63/490,857, filed Mar. 17, 2023. The provisional patent application is herein incorporated by reference in its entirety, including without limitation: the specification, claims, and abstract, as well as any figures, tables, appendices, or drawings thereof.

### TECHNICAL FIELD

This disclosure relates to capped block copolymers, preferably reverse block copolymers capped with a hydrophobic group. The disclosure provides for their synthesis and manufacture as well as methods of using the capped block copolymers for defoaming and antifoaming applications.

### BACKGROUND

It is well known in literature that a protein macromolecule maintains certain conformation or overall structure in its natural state which are dictated by secondary and tertiary structures. Denaturation disrupts the alpha helix and beta sheets in a protein and uncoil it into a random shape. The most common observation of the denaturation process is the precipitation and coagulation of the protein.

Because of this, protein soil presents two major challenges in machine warewashing and CIP cleaning. First, it is difficult to remove. Second, it can produce stable foam, and requires defoaming to avoid cavitation in pumping mechanical action.

Other areas can also require low foaming, or no foaming. For example, in surgical instrument processing and paper/pulp manufacturing there is a need for no foam. Various surfactants have been developed that are low foaming or even defoaming. However, these surfactants often do not provide other needed properties, such as detersive properties and wetting properties.

Many different applications of compositions containing surfactants (e.g., cleaning compositions, rinsing compositions, and softening compositions) can benefit from having lower surface tension so as to provide better wetting of a surface.

Accordingly, it is an objective of this disclosure to provide surfactants that can

address these problems.

A further object of this disclosure is providing surfactants that provide antifoaming and defoaming properties.

Still a further object of this disclosure is providing surfactants that provide low surface tension and good wetting.

Other objects, advantages and features of this disclosure will become apparent from the following specification taken in conjunction with the accompanying figures.

### BRIEF SUMMARY OF PREFERRED EMBODIMENTS

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

The capped block copolymers described herein are provide the advantage of exhibiting good wetting and defoaming properties; this is highly beneficial as there is typically a trade-off in these properties such that high defoaming properties may come at the expense of wetting properties and high wetting properties may come at the expense of defoaming properties. Still a further advantage of the methods described herein is that the synthesis methods are compatible with a variety of commercially available block copolymers.

A preferred embodiment is a surfactant comprising a multiarm block copolymer comprising a polyfunctional moiety and at least 2 alkoxylated arms each of which is selected from the group consisting of —(PO)_{Y}(EO)_{X}, —(EO)_{X}(PO)_{Y}, —(EO)_{X}(PO)_{Y}(EO)_{X}, and —(PO)_{Y}(EO)_{X}(PO)_{Y}; wherein X is about 1 to about 100, and Y is about 1 to about 100; wherein each of the alkxoylated arms comprises a terminus and is capped with a hydrophobic group at the terminus.

Another preferred embodiment is a cleaning, rinsing, or softening composition comprising a surfactant comprising a multiarm block copolymer comprising a polyfunctional moiety and at least 2 alkoxylated arms each of which is selected from the group consisting of —(PO)_{Y}(EO)_{X}, —(EO)_{X}(PO)_{Y}, —(EO)_{X}(PO)_{Y}(EO)_{X}, and —(PO)_{Y}(EO)_{X}(PO)_{Y}; wherein X is about 1 to about 100, and Y is about 1 to about 100; wherein each of the alkxoylated arms comprises a terminus and is capped with a hydrophobic group at the terminus.

Yet another preferred embodiment is a method of synthesizing the surfactant comprising capping a block copolymer with a hydrophobic capping chemistry, wherein the hydrophobic capping chemistry comprises a benzyl group and/or a silyl group.

While multiple embodiments are disclosed, still other embodiments will become apparent to those skilled in the art from the following detailed description, examples, and accompanying figures, which shows and describes illustrative preferred embodiments. Accordingly, the figures and detailed description are to be regarded as illustrative in nature and not restrictive.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE FIGURES

FIG. 1 provides a table showing parameters and results of foam tests for example capped block copolymers synthesized according to the methods disclosed herein.

FIG. 2 provides a table showing the synthesis parameters and observations from synthesis of example capped block copolymers.

FIG. 3 provides a table showing the results of four sample capped block copolymers analyzed for their defoaming and antifoaming properties.

FIG. 4 shows a graph illustrating the comparison of exemplary compositions through sheer strain from 0.01%-500%.

FIG. 5 shows a graph illustrating the comparison of exemplary compositions along a temperature range.

FIG. 6 shows a graph illustrating the comparison of exemplary compositions through sheer strain from 0.01%-500%.

FIG. 7 provides a table showing the results of various surfactants tested to evaluate defoaming properties and compatibility against proteinaceous soils.

FIG. 8A shows a graph illustrating the testing of Tetronic 90R4 with benzyl capped chemistry tested at 10° C. a minute from room temperature to 600° C., with a Nitrogen rate of 60 mL/min.

FIG. 8B shows a graph with a second round of testing the same chemistry and conditions as FIG. 8A.

Various embodiments will be described in detail with reference to the figures. Reference to various embodiments does not limit the scope of the inventions. Figures represented herein are not limitations to the various embodiments according to the inventions and are presented for exemplary illustration of the inventions.

### DETAILED DESCRIPTION

The present disclosure relates to capped block copolymers and compositions containing the same. The disclosure also addresses methods of synthesizing and manufacturing the block copolymers and compositions containing them. The capped block copolymers and compositions containing them as described herein have many advantages over existing compositions comprised of defoaming surfactants. For example, the capped block copolymers have low surface tension and good wetting properties as well as strong defoaming and antifoaming properties. Additionally, the capped block copolymers demonstrated good detersive properties against notoriously difficult proteinaccous soils.

The embodiments disclosed herein are not limited to particular cleaning systems, soils, or substrates, which can vary and are understood by skilled artisans; although in a preferred embodiment, the block copolymers can be warewash, laundry, hard surface cleaning, and paper/pulp manufacturing. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the inventions. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

References to elements herein are intended to encompass any or all of their oxidative states and isotopes. For example, discussion of silicon can include Si⁻⁴, Si⁻³, Si⁻², Si⁻¹, Si¹, Si², Si³, or Si⁴ and any of its isotopes, e.g., ²⁸Si, ²⁹Si, and ³⁰Si.

### Definitions

So that this disclosure may be more readily understood, certain terms are first defined. Unless defined otherwise, all technical and scientific terms used herein have the same meaning as commonly understood by one of ordinary skill in the art to which embodiments pertain. Many methods and materials similar, modified, or equivalent to those described herein can be used in the practice of the embodiments disclosed herein without undue experimentation, the preferred materials and methods are described herein. In describing and claiming the embodiments, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, mass, volume, time, molecular weight, molar ratio, molar percentages, and surface tension. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

As used herein, the term “analog” means a molecular derivative of a molecule. The term is synonymous with the terms “structural analog” or “chemical analog.”

As used herein, the term “oligomer” refers to a molecular complex comprised of between one and ten monomeric units. For example, dimers, trimers, and tetramers, are considered oligomers. Furthermore, unless otherwise specifically limited, the term “oligomer” shall include all possible isomeric configurations of the molecule, including, but are not limited to isotactic, syndiotactic and random symmetries, and combinations thereof. Furthermore, unless otherwise specifically limited, the term “oligomer” shall include all possible geometrical configurations of the molecule.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The methods and compositions of this disclosure may comprise, consist essentially of, or consist of the components and ingredients as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

An “antiredeposition agent” refers to a compound that helps keep suspended in water instead of redepositing onto the object being cleaned. Antiredeposition agents are useful to assist in reducing redepositing of the removed soil onto the surface being cleaned.

The term “weight percent,” “wt. %,” “wt-%,” “percent by weight,” “ % by weight,” and variations thereof, as used herein, refer to the concentration of a substance as the weight of that substance divided by the total weight of the composition and multiplied by 100.

As used herein, the term “cleaning” refers to a method used to facilitate or aid in soil removal.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

As used herein, the phrase “food product” includes any food substance that might require treatment with an antimicrobial agent or composition and that is edible with or without further preparation. Food products include meat (e.g. red meat and pork), seafood, poultry, produce (e.g., fruits and vegetables), eggs, living eggs, egg products, ready to cat food, wheat, seeds, roots, tubers, leafs, stems, corns, flowers, sprouts, seasonings, or a combination thereof. The term “produce” refers to food products such as fruits and vegetables and plants or plant-derived materials that are typically sold uncooked and, often, unpackaged, and that can sometimes be eaten raw.

The term “hard surface” refers to a solid, substantially non-flexible surface such as a countertop, tile, floor, wall, panel, window, plumbing fixture, kitchen and bathroom furniture, appliance, engine, circuit board, dish, partitions, railings, and tables. Hard surfaces may include for example, health care surfaces and food processing surfaces.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.,), or fabric surfaces, e.g., knit, woven, and non-woven surfaces (such as surgical garments, draperies, bed linens, bandages, etc.,), or patient-care equipment (such as respirators, diagnostic equipment, shunts, body scopes, wheel chairs, beds, etc.,), or surgical and diagnostic equipment. Health care surfaces include articles and surfaces employed in animal health care.

As used herein, the term “instrument” refers to the various medical or dental instruments or devices that can benefit from cleaning with a composition according to this disclosure.

As used herein, the phrase “meat product” refers to all forms of animal flesh, including the carcass, muscle, fat, organs, skin, bones and body fluids and like components that form the animal. Animal flesh includes, but is not limited to, the flesh of mammals, birds, fishes, reptiles, amphibians, snails, clams, crustaceans, other edible species such as lobster, crab, etc., or other forms of seafood. The forms of animal flesh include, for example, the whole or part of animal flesh, alone or in combination with other ingredients. Typical forms include, for example, processed meats such as cured meats, sectioned and formed products, minced products, finely chopped products, ground meat and products including ground meat, whole products, and the like.

As used herein, the phrases “medical instrument,” “dental instrument,” “medical device,” “dental device,” “medical equipment,” or “dental equipment” refer to instruments, devices, tools, appliances, apparatus, and equipment used in medicine or dentistry. Such instruments, devices, and equipment can be cold sterilized, soaked or washed and then heat sterilized, or otherwise benefit from cleaning in a composition. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, scopes (e.g., endoscopes, stethoscopes, and arthoscopes) and related equipment, and the like, or combinations thereof.

As used herein, the phrase “plant” or “plant product” includes any plant substance or plant-derived substance. Plant products include, but are not limited to, seeds, nuts, nut meats, cut flowers, plants or crops grown or stored in a greenhouse, house plants, and the like. Plant products include many animal feeds.

As used herein, the term “soil” or “stain” refers to organic and/or inorganic soils such as a non-polar oily substance which may or may not contain particulate matter such as mineral clays, sand, natural mineral matter, carbon black, graphite, kaolin, environmental dust, dirt, etc., and food soil including proteinaccous soils, starchy soils, polysaccharides, fatty soils including saturated and unsaturated fatty soils, food particulate and matter, etc.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the this disclosure include but are not limited to, those that include polypropylene polymers (PP), polycarbonate polymers (PC), melamine formaldehyde resins or melamine resin (melamine), acrilonitrile-butadiene-styrene polymers (ABS), and polysulfone polymers (PS). Other exemplary plastics that can be cleaned using the compounds and compositions of this disclosure include polyethylene terephthalate (PET) polystyrene polyamide.

The terms “water soluble” and “water dispersible” as used herein, means that the polymer is soluble or dispersible in water in the inventive compositions. In general, the polymer should be soluble or dispersible at 25° C. at a concentration of 0.0001% by weight of the water solution and/or water carrier, preferably at 0.001%, more preferably at 0.01% and most preferably at 0.1%.

The term “weight percent,” “wt-%,” “percent by weight,” “ % by weight,” and variations thereof, as used herein, refer to the concentration of a substance as the weight of that substance divided by the total weight of the composition and multiplied by 100. It is understood that, as used here, “percent,” “ %,” and the like are intended to be synonymous with “weight percent,” “wt-%,” etc.

The methods, systems, apparatuses, and compositions disclosed herein may comprise, consist essentially of, or consist of the components and ingredients as described and claimed as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

### Capped Block Copolymers

This disclosure provides capped block copolymers as well as methods of preparing and using the same. The capped block copolymers can be incorporated into a number of different end-use compositions, including, but not limited to, detergent compositions, rinse aid compositions, hard surface cleaning compositions, disinfectant compositions, sanitizing, and decoking compositions. Preferably, the capped block copolymers are multiarmed. Preferred block copolymers may have from about 1 to about 100 moles of EO and from about 1 to about 100 moles of PO, more preferably from about 1 to about 50 moles EO and from about 1 to about 50 moles PO. Some examples of block copolymers include:
—(PO)_{Y}(EO)_{X} —(EO)_{X}(PO)_{Y} —(EO)_{X}(PO)_{Y}(EO)_{X} —(PO)_{Y}(EO)_{X}(PO)_{Y}
   wherein EO represents an ethylene oxide group, PO represents a propylene oxide group, and X and Y reflect the average molecular proportion of each alkylene oxide monomer in the overall block copolymer composition. A preferred EO/PO copolymer is represented by the formula (EO)_{X}(PO)_{Y}(EO)_{X}. In another embodiment, a preferred EO/PO copolymer is represented by the formula (PO)_{Y}(EO)_{X}(PO)_{Y}. Preferably X is in the range of about 1 to about 100 and Y is in the range of about 1 to about 100. In a more preferred embodiment, X is in the range of about 5 to about 90 and Y is in the range of about 5 to about 90. Preferably, X plus Y is in the range of about 2 to about 200, more preferably about 10 to about 180, still more preferably about 15 to about 150. It should be understood that each X and Y in a molecule can be different. In a preferred embodiment, the block copolymer can have a molecular weight (Mn-number average mw) greater than about 200 and less than about 25,000, more preferably from about 500 to about 25,000, most preferably from about 1000 to about 20,000.

These EO/PO block copolymers can include a compact alcohol EO/PO surfactant where the EO and PO groups are in small block form, or random form. In other embodiments, the alkyl alkoxylate includes an ethylene oxide, a propylene oxide, a butylene oxide, a pentalene oxide, a hexylene oxide, a heptalene oxide, an octalene oxide, a nonalene oxide, a decylene oxide, and mixtures thereof. The alkyl group can be linear or branched and is preferably C₁-C₁₈, more preferably C₁₀-C₁₈; most preferably it is a branched alkyl group. Exemplary commercially available surfactants are available, for example, under the tradename PLURONIC® and PLURONIC RR, TETRONIC®, and SURFONIC®.

In a preferred embodiment, the block copolymer comprises a linear or multiarmed EO/PO structures. Most preferably, the block copolymer is a “reverse” block copolymer with the EO inside and the PO on the terminal end. Non-limiting examples are shown below:

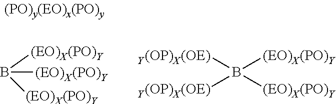

where B is an organic molecule with a polyfunctional moieties, such as a polyol, ethylene diamine, or diethylenetriamine, etc, as the starting point where the arms attach. It should be understood that these are not representative of the orientations of the arms, but merely representative of the potential formulations for purposes of illustrating the attachment of the alkoxylated arms to the starting polyfunctional moiety. Further, X and Y are defined further below where the degree of ethoxylation and propoxylation are discussed.

### Degree of Ethoxylation and Propoxylation

The capped block copolymers disclosed herein include what is often referred to as a “reverse” structure, that is, the EO groups are on the inside and the PO groups are on the outside, (PO)_{Y}(EO)_{X}(PO)_{Y}. Typical reverse block copolymers useful as defoamers have ethoxylation up to about 20% and those useful as wetting agents have ethoxylation between about 20% and 40%. However, typical reverse block copolymers for defoamer or wetting are not capped. Additionally, reverse block copolymers due not usually exhibit both good wetting and defoaming properties, instead they are typically selected for one or the other based on the degree of ethoxylation.

Preferably the ethoxylation is greater than about 20%, more preferably greater than about 20% and up to about 60%, still more preferably from about 25% to about 55%, even more preferably from about 30% to about 50%, still more preferably from about 35% to about 45%, most preferably about 40%.

Preferably the propoxylation is less than about 80%, more preferably from about 40% to less than about 80%, still more preferably from about 45% to about 75%, even more preferably from about 50% to about 70%, still more preferably from about 55% to about 65%, most preferably about 60%.

### Arms

As used herein “arm(s)” refers to the alkoxylated chains; thus a multiarmed capped block copolymer would have more than one alkoxylated chain. The capped block copolymers preferably are multiarmed having at least 2 arms, more preferably at least 3 arms, even more preferably 3-6 arms, still more preferably 4 or 5 arms, and most preferred 4 arms. Preferably, the arms are formed by a branched alkyl group (backbone), which the block copolymer arms attach to. Non-limiting examples of 2 arms, 3 arms, and 4 arms are shown below for illustrative purposes:

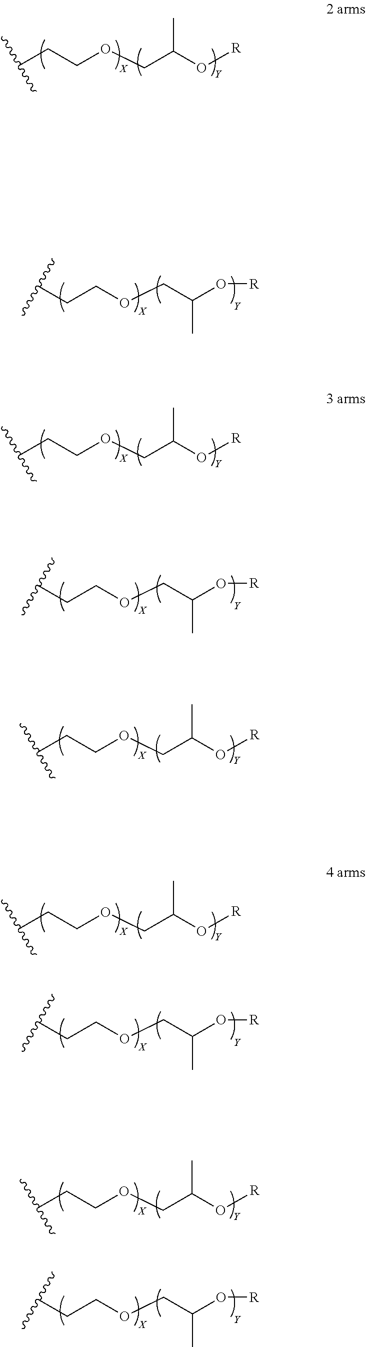

where R is a hydrophobic capping group as disclosed herein, X and Y are as defined above, each preferably between 1 and 100; and the EO/PO arms would be attached to a single backbone such that a single molecule is formed with at least 2 alkoxylated arms, at least 3 alkoxylated arms, at least 4 alkoxylated arms, at least 5 alkoxylated arms, or at least 6 alkoxylated arms. It should be understood that the block copolymer can have arms of different degrees of ethoxylation and/or propoxylation. Additionally, different arms of the block copolymer can have different hydrophobic capping groups at the terminus of each.

It should be understood that the number of arms, nature of the alkyl backbone, and percentages of ethoxylation and propoxylation on the arms can be determined by using a preexisting block copolymer surfactant and capping it according to the methods disclosed herein.

### Capping

The multi-arm capped, reverse block copolymers are capped, i.e., the terminus of each arm is capped with a capping chemistry. Preferred capping chemistries are hydrophobic groups. More preferably, the hydrophobic group comprises a benzyl group and/or a substituted silyl group (R₁R₂R₃Si—) shown below:

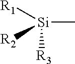

where each of R₁, R₂, and R₃ comprises an alkyl group, a phenol group, or tert-butyl.

Preferred alkyl groups for R1, R2, and/or R3 include straight-chain alkyl groups having between 1 and 10 carbons (i.e., methyl, ethyl, propyl, butyl, pentyl, hexyl, heptyl, octyl, nonyl, and decyl); cyclic alkyl groups (or “cycloalkyl” or “alicyclic” or “carbocyclic” groups), including, but not limited to, cyclopropyl, cyclopentyl, cyclohexyl, cycloheptyl, cyclooctyl, cyclononyl, and cyclodecyl; branched-chain alkyl groups, including, but not limited to isopropyl, tert-butyl, sec-butyl, isobutyl; and alkyl-substituted alkyl groups, including but not limited to, alkyl-substituted cycloalkyl groups and cycloalkyl-substituted alkyl groups.

More preferably the hydrophobic group comprises a benzyl group, trimethylsilyl (TMS), triethylsilyl (TES), tert-butyldimethylsilyl (TBS), tert-butyldiphenylsilyl (TBDPS), triisopropylsilyl (TIPS), or a combination thereof. These preferred silyl-based capping chemistries are shown below:

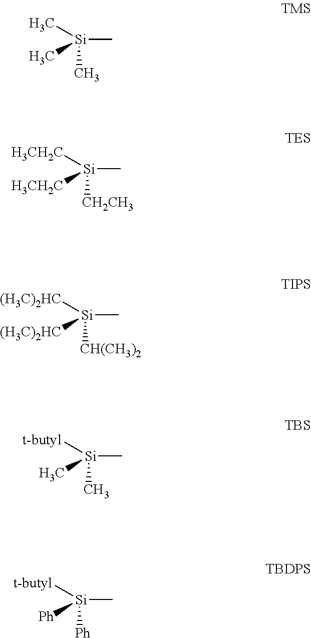

In the instance where there is a combination of hydrophobic groups utilized, this is due to capping of the different arms (e.g., two arms capped with TIPS and two arms capped with a benzyl group). Most preferably the hydrophobic group comprises a benzyl group, trimethylsilyl (TMS), triisopropylsilyl (TIPS), or a combination thereof.

In an embodiment where the block copolymer has two arms, one or both arms can be capped. In an embodiment where the block copolymer has three arms, one, two or three arms can be capped. In an embodiment where the block copolymer has four arms, one, two, three or four arms can be capped. In an embodiment where the block copolymer has five arms, one, two, three, four or five arms can be capped. In an embodiment where the block copolymer has six arms, one, two, three, four, five, or six arms can be capped.

We have surprisingly found that the ratio of capped to uncapped arms can impact the thermal stability of the capped block copolymers. We found that thermal stability is increased with increased capping; thus, it is preferred to have a ratio of at least greater than 1:1 for capped to uncapped arms, most preferably all arms being capped for high temperature use applications. Thus, in applications requiring thermal stability it is preferable to have at least two of three arms capped, at least three of four arms capped, at least four of five arms capped, at least four of six arms capped, at least five of six arms capped, most preferably all arms capped.

We surprisingly found that retaining some uncapped arms improves viscoelasticity of the capped block copolymers. Most preferably we found that a ratio of about 2:1 to about 4:1 capped to uncapped arms; most preferably about 3:1 capped to uncapped arms. Thus, in applications where viscoelasticity is desired, two of three arms are capped, three of four arms are capped, three of five arms are capped, four of five arms are capped, four of six arms are capped, five of six arms are capped.

Beneficially, the capped block copolymers disclosed herein have a low surface tension. Preferably a surface tension of less than about 35 dynes/cm, more preferably less than about 34 dynes/cm, still more preferably less than about 33 dynes/cm, even more preferably less than about 32 dynes/cm, yet more preferably less than about 31 dynes/cm, still more preferably less than about 30 dynes, even more preferably less than about 29 dynes, yet more preferably less than about 28 dynes/cm, still more preferably less than about 27 dynes/cm, even more preferably less than about 26 dynes/cm, yet more preferably less than about 25 dynes/cm, still more preferably less than about 24 dynes, even more preferably less than about 23 dynes, yet more preferably less than about 22 dynes/cm, still more preferably less than about 21 dynes, most preferably about 20 dynes/cm or less; when tested under ambient temperature and humidity.

As discussed above, the problems associated with proteinaceous soils are well known and particularly problematic for machine warewash and CIP cleaning. Without wishing to be bound by the theory, we believe for optimal performance, a defoaming surfactant should be surface active enough to penetrate protein stabilized foam lamellae, partially denature the protein to a certain degree to produce proper defoaming, yet without full denaturation to cause precipitation/coagulation of the protein to cause deposition problem.

### Synthesis

The capped block copolymers can be synthesized by obtaining an existing block copolymer and performing a capping procedure via capping chemistry. The type of capping performed can be influenced by: (i) the hydrophobic capping group intended to be added to the block copolymer and (ii) the nature of the block copolymer being capped. As discussed above, preferred hydrophobic groups include benzyl groups and silyl groups.

Benzyl Capping

Benzyl capping can be added by benzylation, preferably performed under nitrogen or another inert atmosphere. Preferably, the block copolymer is deprotonated to prepare it for benzylation.

A preferred deprotonation step via the addition of MeONa in methanol (preferably about 15% to about 35% MeONa) under inert atmosphere (preferably nitrogen). Optionally, the mixture is stirred. Preferably the mixture is heated; most preferably to about 100° C. During the heating step nitrogen purging is preferably be performed. The mixture remains in the heated temperature, preferably with the nitrogen purging, for a time period sufficient for deprotonation to occur. In a preferred embodiment, a sufficient amount of time is at least about 60 minutes, at least about 70 minutes, at least about 80 minutes, at least about 90 minutes, at least about 100 minutes, at least about 110 minutes, at least about 120 minutes.

After deprotonation and distillation of methanol, the mixture is preferably cooled to about 75° C. at which point a benzyl salt is added; preferably in an amount of at least 2 molar equivalents, more preferably between about 3 to about 5 molar equivalents to the block copolymer. The resulting mixture can then be stirred at this temperature for 2 hours or until completion of the benzylation under nitrogen blanketing. Upon completion of the benzylation, the mixture is cooled to room temperature.

Any suitable benzyl salt can be added to the deprotonated mixture, including, but not limited to, benzyl chloride.

### Silylation

Silyl capping can be added by silylation, preferably performed under nitrogen or another inert atmosphere.

The block copolymer is mixed with a solvent. Any suitable solvent can be applied and those skilled in the art can select a suitable solvent. A preferred solvent is tetrahydrofuran (THF). The block copolymer and solvent are mixed by any suitable stirring/mixing method (solvent mixing step). A preferred method is with a stir bar; however, other methods of stirring/mixing can be performed. In a preferred embodiment, the stirring/mixing is first performed at room temperature and then performed under cool temperature conditions (e.g., in an ice bath). The stirring/mixing can be performed for any suitable amount of time depending on the volume of blocked copolymer and solvent. Under a preferred embodiment, the stirring/mixing is performed for a time of up to about 6 hours, up to about 5 hours, up to about 4.5 hours, up to about 4 hours, up to about 3.5 hours, up to about 3 hours, up to about 2.5 hours, up to about 2 hours, up to about 110 minutes, up to about 100 minutes, up to about 90 minutes, up to about 85 minutes, up to about 80 minutes up to about 75 minutes, up to about 70 minutes, up to about 65 minutes, up to about 60 minutes, up to about 55 minutes, up to about 50 minutes, up to about 45 minutes, up to about 40 minutes, up to about 35 minutes, up to about 30 minutes. In a preferred embodiment the stirring/mixing is performed under an inert atmosphere, including, but not limited to nitrogen.

Following the solvent mixing step, the capping chemistry salt is added (capping chemistry mixing step). For example, a salt of TMS, TES, TIPS, TBS, or TBDPS is added to the mixture of solvent and block copolymer. The silyl capping chemistry is preferably added in an amount of at least about 2 molar equivalents, at least about 2.5 molar equivalents, at least about 3 molar equivalents, at least about 4 molar equivalents, at least about 4.5 molar equivalents, at least about 5 molar equivalents, at least about 5.5 molar equivalents, at least about 6 molar equivalents, at least about 6.5 molar equivalents, at least about 7 molar equivalents to the block copolymer. In a preferred embodiment, the silyl capping chemistry is preferably added in an amount of between about 3 and about 20 molar equivalents, more preferably between about 4 and about 18 molar equivalents, still more preferably between about 5 and about 15 molar equivalents, most preferably between about 7 and about 13 molar equivalents to the block copolymer.

During and/or after the addition of the capping chemistry, the solution is preferably mixed. Again, any suitable method of stirring/mixing can be performed; a preferred method is via stir bar. Under a preferred embodiment, the stirring/mixing is performed for a time of up to about 6 hours, up to about 5 hours, up to about 4.5 hours, up to about 4 hours, up to about 3.5 hours, up to about 3 hours, up to about 2.5 hours, up to about 2 hours, up to about 110 minutes, up to about 100 minutes, up to about 90 minutes, up to about 85 minutes, up to about 80 minutes up to about 75 minutes, up to about 70 minutes, up to about 65 minutes, up to about 60 minutes, up to about 55 minutes, up to about 50 minutes, up to about 45 minutes, up to about 40 minutes, up to about 35 minutes, up to about 30 minutes.

Triethanolamine (TEA) is preferably added to the mixture of capping chemistry and block copolymer. This can be done before, during or after the addition of the capping chemistry. In a most preferred embodiment, the TEA is added after the capping chemistry. The TEA is preferably added in an amount of at least about 2 molar equivalents, at least about 2.5 molar equivalents, at least about 3 molar equivalents, at least about 4 molar equivalents, at least about 4.5 molar equivalents, at least about 5 molar equivalents, at least about 5.5 molar equivalents, at least about 6 molar equivalents, at least about 6.5 molar equivalents, at least about 7 molar equivalents, at least about 7.5 molar equivalents, at least about 8 molar equivalents to the block copolymer. In a preferred embodiment, the TEA is preferably added in an amount of between about 5 and about 15 molar equivalents, more preferably between about 6 and about 13 molar equivalents, still more preferably between about 7 and about 12 molar equivalents, most preferably between about 7 and about 11 molar equivalents to the block copolymer. Preferably, the mixture of solvent, block copolymer, capping chemistry and TEA is stirred or otherwise mixed. A preferable technique is with a stir bar; however, other stirring/mixing mechanisms are suitable.

Preferably, the stirring/mixing is performed under cooled temperature conditions, such as an ice bath; however, permitting the solution to raise to room temperature is also appropriate. Preferably the solution is the stirred for a time of up to about 6 hours, up to about 5 hours, up to about 4.5 hours, up to about 4 hours, up to about 3.5 hours, up to about 3 hours, up to about 2.5 hours, up to about 2 hours, up to about 110 minutes, up to about 100 minutes, up to about 90 minutes, up to about 85 minutes, up to about 80 minutes up to about 75 minutes, up to about 70 minutes, up to about 65 minutes, up to about 60 minutes, up to about 55 minutes, up to about 50 minutes, up to about 45 minutes, up to about 40 minutes, up to about 35 minutes, up to about 30 minutes.

Preferably, the solution is stirred/mixed under cooled temperature conditions, then permitted to raise to room temperature and stirred/mixed further. Once at room temperature, the solution is preferably stirred for a time period of at least about 1 hour, at least about 2 hours, at least about 3 hours, at least about 4 hours, at least about 5 hours, at least about 6 hours, at least about 7 hours, at least about 8 hours, at least about 9 hours, at least about 10 hours, at least about 11 hours, at least about 12 hours, at least about 13 hours, at least about 14 hours, at least about 15 hours, at least about 16 hours, at least about 17 hours, at least about 18 hours, at least about 19 hours, at least about 20 hours, at least about 21 hours, at least about 22 hours, at least about 23 hours, at least about 24 hours.

After mixing/stirring, the solution is preferably quenched with an acid and/or brine solution. If employing an acid, a preferred acid is HCl; however, other quenching acids can be used.

After quenching, the solvent is preferably removed. Any suitable method for removing solvent can be applied. Preferred methods include evaporation techniques such as heating, vacuum evaporation, and/or rotavapor evaporation.

The capped block copolymer is thus dried, separated and collected.

### End-Use Compositions

The capped block copolymers disclosed herein can be incorporated into a variety of end-use compositions. Such can include detergents (e.g., laundry and warewash), hard surface cleaning compositions, sanitizing compositions, and compositions useful in paper/pulp manufacturing. A benefit of the compositions is that they have the potential to provide very good wetting properties at the chains end (low surface tension of the cap) and also very good defoaming properties. Thus, the compositions are particularly useful for end-uses that require very low foam or no foam. This can include, but is not limited to, machine warewash, surgical instrument cleaning, hard surface cleaning and/or sanitizing, and paper/pulp manufacturing. The compositions can also have strong thermal stability properties making them useful for high temperature applications (e.g., applications where the temperature exceeds about 300° C., exceeds about 350° C., or exceeds about 400° C.). Such applications include, but are not limited to, decoking.

Example compositions are provided below as illustrative of anticipated compositional makeups of such end use compositions including the capped block copolymers disclosed below in Tables 1A-1F; each of the wt. % integers specified in the following tables is to be considered preceded by the term “about”.

### Example Hard Surface Cleaning Composition

TABLE 1A

| | First | Second | Third | Fourth |
|---|---|---|---|---|
| | Example | Example | Example | Example |
| | Range | Range | Range | Range |
| Ingredient | wt. % | wt. % | wt. % | wt. % |
| Surfactant (comprising | 1-20 | 1-10 | 30-95 | 30-95 |
| capped block copolymer) | | | | |
| Builder/Stabilizing | 0.01-30 | 0.1-40 | 0.1-40 | 0.1-40 |
| Agent | | | | |
| Alkalinity Source | 30-90 | 40-90 | 20-50 | 0-10 |
| Water | 0.01-20 | 0.1-10 | 0.01-10 | 0.01-10 |
| Optional additional | 0-40 | 0.01-35 | 0.05-30 | 0.1-25 |
| functional ingredients | | | | |

### Example Laundry Composition

TABLE 1B

| | First | Second | Third | Fourth |
|---|---|---|---|---|
| | Example | Example | Example | Example |
| | Range | Range | Range | Range |
| Ingredient | wt. % | wt. % | wt. % | wt. % |
| Alkalinity Source | 30-90 | 40-80 | 50-70 | 55-65 |
| Surfactant (comprising | 0.01-40 | 0.1-35 | 1-30 | 5-30 |
| capped block copolymer) | | | | |
| Builders/Stabilizing | 1-50 | 2-40 | 5-30 | 7.5-25 |
| Agents | | | | |
| Optional Additional | 0-40 | 0.01-35 | 0.1-30 | 1-25 |
| Functional Ingredients | | | | |
| Water | 0-20 | 0.01-10 | 0.1-10 | 0.1-10 |

### Example Machine Warewash Composition

TABLE 1C

| | First | Second | Third | Fourth |
|---|---|---|---|---|
| | Example | Example | Example | Example |
| | Range | Range | Range | Range |
| Ingredient | wt. % | wt. % | wt. % | wt. % |
| Alkalinity Source | 50-95 | 55-90 | 60-85 | 60-85 |
| Optional Solidification | 0-25 | 1-20 | 5-15 | 5-15 |
| Aid | | | | |
| Surfactant (comprising | 1-35 | 5-30 | 5-25 | 7.5-25 |
| capped block copolymer) | | | | |
| Additional optional | 0-30 | 0.01-30 | 0.1-25 | 0.5-20 |
| functional ingredients | | | | |
| Water | 0-20 | 0.01-15 | 0.1-10 | 1-10 |

### Example Paper/Pulp Softening and Processing Composition

TABLE 1D

| | First | Second | Third | Fourth |
|---|---|---|---|---|
| | Example | Example | Example | Example |
| | Range | Range | Range | Range |
| Ingredient | wt. % | wt. % | wt. % | wt. % |
| Softening Composition | 10-80 | 10-60 | 15-60 | 20-60 |
| Processing Aid | 0.01-10 | 0.5-7 | 0.5-5 | 1-4.5 |
| Optional Solidification | 0-25 | 1-25 | 5-25 | 10-25 |
| Aid | | | | |
| Surfactant (comprising | 0.01-20 | 0.1-15 | 0.5-15 | 1-12 |
| capped block copolymer) | | | | |
| Additional Optional | 0-60 | 0.1-60 | 1-60 | 1-60 |
| Functional Ingredients | | | | |

Ingredients useful for paper/pulp softening and processing compositions are disclosed in U.S. Ser. No. 17/645,560, published as U.S. Pat. No. 2022,0204889, of which paragraphs [0012]-[0031] and [0042-0216] are incorporated by reference as if set forth herein.

### Example Rinse Aid Composition

TABLE 1E

| | First | Second | Third | Fourth |
|---|---|---|---|---|
| | Example | Example | Example | Example |
| | Range | Range | Range | Range |
| Ingredient | wt. % | wt. % | wt. % | wt. % |
| Alkalinity Source | 10-95 | 25-90 | 40-85 | 45-75 |
| Builder | 0.1-50 | 1-50 | 5-45 | 10-35 |
| Surfactant (comprising | 0.01-30 | 0. 1-25 | 0.1-20 | 1-10 |
| capped block copolymer) | | | | |
| Additional Functional | 0-40 | 0-30 | 0-25 | 0-20 |
| Ingredients | | | | |

### Example Surgical Instrument Cleaning Composition

TABLE 1F

| | First | Second | Third | Fourth |
|---|---|---|---|---|
| | Example | Example | Example | Example |
| | Range | Range | Range | Range |
| Ingredient | wt. % | wt. % | wt. % | wt. % |
| Alkalinity Source | 15-75 | 20-70 | 25-70 | 30-65 |
| Acid | 10-50 | 12-50 | 15-45 | 17.5-40 |
| Enzyme | 0.1-25 | 0.5-20 | 1-15 | 1.5-12.5 |
| Surfactant (comprising | 0.1-25 | 0.5-20 | 1-15 | 2-15 |
| capped block copolymer) | | | | |
| Optional ingredients | 0-25 | 0.01-20 | 0.1-20 | 0.1-18 |

A use solution may be prepared from the end-use compositions disclosed in Tables 1A-1F by diluting the concentrated end-use compositions with water at a dilution ratio that provides a use solution. The water that is used to dilute the concentrate to form the use solution can be referred to as water of dilution or a diluent, and can vary from one location to another. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water. Particularly, the concentrate is diluted at a ratio of between about 1:100 and about 1:5,000 concentrate to water. More particularly, the concentrate is diluted at a ratio of between about 1:250 and about 1:2,000 concentrate to water. In a use solution, the detergent composition is present between about 10 ppm and about 10,000 ppm, preferably between about 200 ppm and about 5000 ppm, more preferably between about 500 ppm and about 2000 ppm, and in a most preferred embodiment between about 750 ppm and about 1500 ppm.

In some embodiments, the end-use composition preferably provide efficacy at low use dilutions, i.e., require less volume to clean effectively. In an aspect, a concentrated liquid detergent composition may be diluted in water prior to use at dilutions ranging from about 1/16 oz./gal. to about 2 oz./gal. or more. A detergent concentrate that requires less volume to achieve the same or better cleaning efficacy and provides hardness scale control and/or other benefits at low use dilutions is desirable.

### Ingredients for End-Use Compositions

Various ingredients can be used in combination with the capped block copolymers disclosed herein to prepare an end-use composition. The is a list of preferred ingredients for different types of end-use compositions, including, those disclosed above in Tables 1A-1F. Additional ingredients could also be included depending on the end-use composition. The following are preferred and non-limiting.

### Acid Source

In some embodiments an end-use composition can include an acid source. Suitable acid sources, can include, organic and/or inorganic acids. Examples of suitable organic acids include carboxylic acids such as but not limited to hydroxyacetic (glycolic) acid, citric acid, formic acid, acetic acid, propionic acid, butyric acid, valeric acid, caproic acid, trichloroacetic acid, urea hydrochloride, and benzoic acid, among others. Organic dicarboxylic acids such as oxalic acid, malonic acid, gluconic acid, itaconic acid, succinic acid, glutaric acid, maleic acid, fumaric acid, adipic acid, and terephthalic acid among others are also useful in accordance with this disclosure. Any combination of these organic acids may also be used intermixed or with other organic acids which allow adequate formation of the end-use compositions.

Inorganic acids that can be included in some embodiments include sulfuric acid, sulfamic acid, methylsulfamic acid, hydrochloric acid, hydrobromic acid, and nitric acid among others. These acids may also be used in combination with other inorganic acids or with those organic acids mentioned above. In a preferred embodiment, the acid is an inorganic acid.

In some embodiments an end-use composition can have an acidic pH. In such an embodiment, the pH is preferably between 1 and 7. In another aspect, the acid source can be included as a pH modifier or neutralizer in a basic composition to achieve a desired pH.

### Activators

In some embodiments, an end-use composition can have improved the antimicrobial activity or bleaching activity by the addition of a material which, when the composition is placed in use, reacts with the active oxygen to form an activated component. For example, in some embodiments, a peracid or a peracid salt is formed. For example, in some embodiments, tetraacetylethylene diamine can be included within the composition to react with the active oxygen and form a peracid or a peracid salt that acts as an antimicrobial agent. Other examples of active oxygen activators include transition metals and their compounds, compounds that contain a carboxylic, nitrile, or ester moiety, or other such compounds known in the art. In an embodiment, the activator includes tetraacetylethylene diamine; transition metal; compound that includes carboxylic, nitrile, amine, or ester moiety; or mixtures thereof.

In some embodiments, an activator component can include in the range of up to about 75% by wt. of the end-use composition, in some embodiments, in the range of about 0.01 to about 20% by wt., or in some embodiments, in the range of about 0.05 to 10% by wt. of the end-use composition. In some embodiments, an activator for an active oxygen compound combines with the active oxygen to form an antimicrobial agent.

The activator can be coupled to an end-use composition by any of a variety of methods for coupling one solid cleaning composition to another. For example, the activator can be in the form of a solid that is bound, affixed, glued or otherwise adhered to the solid cleaning composition. Alternatively, the solid activator can be formed around and encasing the solid cleaning composition. By way of further example, the solid activator can be coupled to an end-use composition by the container or package for the composition, such as by a plastic or shrink wrap or film.

### Alkalinity Source

An end-use composition can include an effective amount of one or more alkalinity sources. An effective amount of one or more alkaline sources should be considered as an amount that provides a composition having a pH between about 7 and about 14. In a particular embodiment the end-use compositions can have a pH of between about 7.5 and about 13.5. During a wash cycle the use solution can have a pH between about 6 and about 14. In particular embodiments, the use solution can have a pH between about 6 and 14. If the end-use composition includes an enzyme composition, the pH may be modulated to provide the optimal pH range for the enzyme compositions effectiveness. In a particular embodiment incorporating an enzyme composition in the end-use composition, the optimal pH is between about 10 and about 11.

Examples of suitable alkaline sources for the end-use compositions include, but are not limited to carbonate-based alkalinity sources, including, for example, carbonate salts such as alkali metal carbonates; caustic-based alkalinity sources, including, for example, alkali metal hydroxides; other suitable alkalinity sources may include metal silicate, metal borate, and organic alkalinity sources. Exemplary alkali metal carbonates that can be used include, but are not limited to, sodium carbonate, potassium carbonate, bicarbonate, sesquicarbonate, and mixtures thereof. Exemplary alkali metal hydroxides that can be used include, but are not limited to sodium, lithium, or potassium hydroxide. Exemplary metal silicates that can be used include, but are not limited to, sodium or potassium silicate or metasilicate. Exemplary metal borates include, but are not limited to, sodium or potassium borate.

Organic alkalinity sources are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

In general, alkalinity sources are commonly available in either aqueous or powdered form. Preferably, the alkalinity source is in a solid form. The alkalinity can be added to the composition in any form known in the art, including as solid beads, granulated or particulate form, dissolved in an aqueous solution, or a combination thereof.

### Anti-Redeposition Agents

The end-use compositions can optionally include an anti-redeposition agent capable of facilitating sustained suspension of soils in a cleaning or rinse solution and preventing removed soils from being redeposited onto the substrate being cleaned and/or rinsed. Some examples of suitable anti-redeposition agents can include fatty acid amides, fluorocarbon surfactants, complex phosphate esters, styrene maleic anhydride copolymers, and cellulosic derivatives such as hydroxyethyl cellulose, hydroxypropyl cellulose, and the like. An end-use composition can include up to about 10 wt. %, and in some embodiments, in the range of about 1 to about 5 wt. %, of an anti-redeposition agent.

### Bleaching Agents

The end-use compositions can optionally include bleaching agent. Bleaching agent can be used for lightening or whitening a substrate, and can include bleaching compounds capable of liberating an active halogen species, such as Cl₂, Br₂, —OCl⁻ and/or —OBr⁻, or the like, under conditions typically encountered during the cleansing process. Suitable bleaching agents for use can include, for example, chlorine-containing compounds such as a chlorine, a hypochlorite, chloramines, of the like. Some examples of halogen-releasing compounds include the alkali metal dichloroisocyanurates, chlorinated trisodium phosphate, the alkali metal hypochlorites, monochloramine and dichloroamine, and the like. Encapsulated chlorine sources may also be used to enhance the stability of the chlorine source in the composition (sec, for example, U.S. Pat. Nos. 4,618,914 and 4,830,773, the disclosures of which are incorporated by reference herein). A bleaching agent may also include an agent containing or acting as a source of active oxygen. The active oxygen compound acts to provide a source of active oxygen, for example, may release active oxygen in aqueous solutions. An active oxygen compound can be inorganic or organic, or can be a mixture thereof. Some examples of active oxygen compound include peroxygen compounds, or peroxygen compound adducts. Some examples of active oxygen compounds or sources include hydrogen peroxide, perborates, sodium carbonate peroxyhydrate, phosphate peroxyhydrates, potassium permonosulfate, and sodium perborate mono and tetrahydrate, with and without activators such as tetraacetylethylene diamine, and the like. An end-use composition may include a minor but effective amount of a bleaching agent, for example, in some embodiments, in the range of up to about 10 wt. %, and in some embodiments, in the range of about 0.1 to about 6 wt. %.

### Chelating/Sequestering Agents

The end-use compositions may also include effective amounts of

chelating/sequestering agents, also referred to as builders. In addition, the end-use compositions may optionally include one or more additional builders as a functional ingredient. In general, a chelating agent is a molecule capable of coordinating (i.e., binding) the metal ions commonly found in water sources to prevent the metal ions from interfering with the action of the other ingredients of a rinse aid or other cleaning composition. The chelating/sequestering agent may also function as a water conditioning agent when included in an effective amount. In some embodiments, an end-use composition can include in the range of up to about 70 wt. %, or in the range of about 1-60 wt. %, of a chelating/sequestering agent.

In some embodiments, an end-use composition is phosphate-free and/or sulfate-free. In embodiments of the end-use compositions that are phosphate-free, the additional functional materials, including builders exclude phosphorous-containing compounds such as condensed phosphates and phosphonates.

Suitable additional builders include aminocarboxylates and polycarboxylates. Some examples of aminocarboxylates useful as chelating/sequestering agents, include, N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), and the like. Some examples of polymeric polycarboxylates suitable for use as sequestering agents include those having a pendant carboxylate (——CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

In embodiments of the end-use compositions that are not phosphate-free, added chelating/sequestering agents may include, for example a condensed phosphate, a phosphonate, and the like. Some examples of condensed phosphates include sodium and potassium orthophosphate, sodium and potassium pyrophosphate, sodium tripolyphosphate, sodium hexametaphosphate, and the like. A condensed phosphate may also assist, to a limited extent, in solidification of the composition by fixing the free water present in the composition as water of hydration.

In embodiments of an end-use composition is not phosphate-free, and the composition may include a phosphonate such as l-hydroxyethane-1,1-diphosphonic acid CH₃C(OH)[PO(OH)₂]₂; aminotri(methylenephosphonic acid) N[CH₂ PO(OH)₂]₃; aminotri(methylenephosphonate), sodium salt

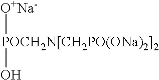

2-hydroxyethyliminobis(methylenephosphonic acid) HOCH₂ CH₂ N[CH₂ PO(OH)₂]₂; diethylenetriaminepenta(methylenephosphonic acid) (HO)₂ POCH₂ N[CH₂ N[CH₂ PO(OH)₂]₂]₂; diethylenetriaminepenta(methylenephosphonate), sodium salt C₉ H₍₂₈₋ₓ₎ N₃ NaₓO₁₅P₅ (x=7); hexamethylenediamine(tetramethylenephosphonate), potassium salt C₁₀ H₍₂₈₋ₓ₎N₂KₓO₁₂P₄ (x=6); bis(hexamethylene)triamine(pentamethylenephosphonic acid) (HO₂)POCH₂N[(CH₂)₆ N[CH₂ PO(OH)₂]₂]₂; and phosphorus acid H3PO3. In some embodiments, a phosphonate combination such as ATMP and DTPMP may be used. A neutralized or alkaline phosphonate, or a combination of the phosphonate with an alkali source prior to being added into the mixture such that there is little or no heat or gas generated by a neutralization reaction when the phosphonate is added can be used.

For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein.

### Dyes/Odorants

Various dyes, odorants including perfumes, and other aesthetic enhancing agents may also be included in an end-use composition. Dyes may be included to alter the appearance of the composition, as for example, FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

Fragrances or perfumes that may be included in an end-use composition include, for example, terpenoids such as citronellol, aldehydes such as amyl cinnamaldehyde, a jasmine such as CIS-jasmine or jasmal, vanillin, and the like.

### Fillers

The end-use compositions can optionally include a minor but effective amount of one or more of a filler. Some examples of suitable fillers may include sodium chloride, starch, sugars, C₁-C₁₀ alkylene glycols such as propylene glycol, sulfates, PEG, urea, sodium acetate, magnesium sulfate, sodium acetate, magnesium sulfate, sodium carbonate and the like. In some embodiments, a filler can be included in an amount in the range of up to about 50 wt. %, and in some embodiments, in the range of about 1-15 wt. %.

### Functional Polydimethylsiloxones

The end-use compositions can also optionally include one or more functional polydimethylsiloxones. For example, in some embodiments, a polyalkylene oxide-modified polydimethylsiloxane, nonionic surfactant or a polybetaine-modified polysiloxane amphoteric surfactant can be employed as an additive. Both, in some embodiments, are linear polysiloxane copolymers to which polyethers or polybetaines have been grafted through a hydrosilation reaction. Some examples of specific siloxane surfactants are known as SILWET® surfactants available from Union Carbide or ABIL® polyether or polybetaine polysiloxane copolymers available from Goldschmidt Chemical Corp., and described in U.S. Pat. No. 4,654,161 which patent is incorporated herein by reference. In some embodiments, the particular siloxanes used can be described as having, e.g., low surface tension, high wetting ability and excellent lubricity. For example, these surfactants are said to be among the few capable of wetting polytetrafluoroethylene surfaces. The siloxane surfactant employed as an additive can be used alone or in combination with a fluorochemical surfactant. In some embodiments, the fluorochemical surfactant employed as an additive optionally in combination with a silane, can be, for example, a nonionic fluorohydrocarbon, for example, fluorinated alkyl polyoxyethylene ethanols, fluorinated alkyl alkoxylate and fluorinated alkyl esters.

Further description of such functional polydimethylsiloxones and/or fluorochemical surfactants are described in U.S. Pat. Nos. 5,880,088; 5,880,089; and 5,603,776, all of which patents are incorporated herein by reference. We have found, for example, that the use of certain polysiloxane copolymers in a mixture with hydrocarbon surfactants provides excellent rinse aids on plastic ware. We have also found that the combination of certain silicone polysiloxane copolymers and fluorocarbon surfactants with conventional hydrocarbon surfactants also provide excellent rinse aids on plastic ware. This combination has been found to be better than the individual components except with certain polyalkylene oxide-modified polydimethylsiloxanes and polybetaine polysiloxane copolymers, where the effectiveness is about equivalent. Therefore, some embodiments encompass the polysiloxane copolymers alone and the combination with the fluorocarbon surfactant can involve polyether polysiloxanes, the nonionic siloxane surfactants. The amphoteric siloxane surfactants, the polybetaine polysiloxane copolymers may be employed alone as the additive in the end-use compositions to provide the same results.

In some embodiments, the end-use compositions may include functional polydimethylsiloxones in an amount in the range of up to about 10 wt. %. For example, some embodiments may include in the range of about 0.1 to 10 wt. % of a polyalkylene oxide-modified polydimethylsiloxane or a polybetaine-modified polysiloxane, optionally in combination with about 0.1 to 10 wt. % of a fluorinated hydrocarbon nonionic surfactant.

### Hardening/Solidification Agents/Solubility Modifiers

In some embodiments, one or more solidification agents may be included in an end-use composition. Examples of hardening agents include urea, an amide such stearic monoethanolamide or lauric diethanolamide or an alkylamide, and the like; sulfate salts or sulfated surfactants, and aromatic sulfonates, and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the active ingredients may be dispensed from the solid composition over an extended period of time.

Suitable aromatic sulfonates include, but are not limited to, sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and/or sodium butyl naphthalene. Preferred aromatic sulfonates include sodium xylene sulfonate and sodium cumene sulfonate.

The amount of solidification agent included in an end-use composition can be dictated by the desired effect. In general, an effective amount of solidification agent is considered an amount that acts with or without other materials to solidify the end-use composition. Typically, for solid embodiments, the amount of solidification agent in a cleaning composition is in a range of about 10 to about 80% by weight of the end-use composition, preferably in the range of about 20 to about 75% by weight more preferably in the range of about 20 to about 70% by weight of the end-use composition. In an aspect, the solidification agent is substantially free of sulfate. For example, the end-use composition may have less than 1 wt. % sulfate, preferably less than 0.5 wt. %, more preferably less than 0.1wt. %. In a preferred embodiment the end-use composition is free of sulfate.

In certain embodiments it can be desirable to have a secondary solidification agent. In compositions containing secondary solidification the composition may include a secondary solidification agent in an amount in the range of up to about 50 wt. %. In some embodiments, secondary hardening agents may be present in an amount in the range of about 5 to about 35 wt. %, often in the range of about 10 to about 25 wt. %, and sometimes in the range of about 5 to about 15 wt.-%.

In some embodiments, one or more additional hardening agents may be included in an end-use composition. Examples of hardening agents include an amide such stearic monoethanolamide or lauric diethanolamide, or an alkylamide, and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the ingredients may be dispensed from the solid composition over an extended period of time. The end-use composition may include a secondary hardening agent in an amount in the range of up to about 30 wt. %. In some embodiments, secondary hardening agents may be present in an amount in the range of about 5 to about 25 wt. %, often in the range of about 10 to about 25 wt. %, and sometimes in the range of about 5 to about 15 wt. %.

### Humectant

The end-use composition can also optionally include one or more humectants. A humectant is a substance having an affinity for water. The humectant can be provided in an amount sufficient to aid in reducing the visibility of a film on the substrate surface. The visibility of a film on substrate surface is a particular concern when the rinse water contains in excess of 200 ppm total dissolved solids. Accordingly, in some embodiments, the humectant is provided in an amount sufficient to reduce the visibility of a film on a substrate surface when the rinse water contains in excess of 200 ppm total dissolved solids compared to a rinse agent composition not containing the humectant. The terms “water solids filming” or “filming” refer to the presence of a visible, continuous layer of matter on a substrate surface that gives the appearance that the substrate surface is not clean.

Some example humectants that can be used include those materials that contain greater than 5 wt. % water (based on dry humectant) equilibrated at 50% relative humidity and room temperature. Exemplary humectants that can be used include glycerin, propylene glycol, sorbitol, alkyl polyglycosides, polybetaine polysiloxanes, and mixtures thereof. In some embodiments, an end-use composition can include humectant in an amount in the range of up to about 75% based on the total composition, and in some embodiments, in the range of about 5 wt. % to about 75 wt. % based on the weight of the composition.

### Hydratable Salt

An end-use composition can optionally comprise at least one hydratable salt. In an embodiment the hydratable salt is sodium carbonate (aka soda ash or ash) and/or potassium carbonate (aka potash). In a preferred aspect, the hydratable salt is sodium carbonate and excludes potassium carbonate. The hydratable salt can be provided in the ranges from between approximately 20% and approximately 90% by weight, preferably between approximately 25% and approximately 90% by weight, and more preferably between approximately 30% and approximately 70% by weight hydratable salt, such as sodium carbonate. Those skilled in the art will appreciate other suitable component concentration ranges for obtaining comparable properties of the solidification matrix.

In other embodiments, the hydratable salt may be combined with other solidification agents. For example, the hydratable salt may be used with additional solidification agents that are inorganic in nature and may also act optionally as a source of alkalinity. In certain embodiments, the secondary solidification agent may include, but are not limited to:

additional alkali metal hydroxides, anhydrous sodium carbonate, anhydrous sodium sulfate, anhydrous sodium acetate, and other known hydratable compounds or combinations thereof. According to a preferred embodiment, the secondary hydratable salt comprises sodium metasilicate and/or anhydrous sodium metasilicate. The amount of secondary solidifying agent necessary to achieve solidification depends upon several factors, including the exact solidifying agent employed, the amount of water in the composition, and the hydration capacity of the other end-use composition components. In certain embodiments, the secondary solidifying agent may also serve as an additional alkaline source.

### Polymer

An end-use composition can include a polymer or a polymer system comprised of at least one polycarboxylic acid polymer, copolymer, and/or terpolymer. Particularly suitable polycarboxylic acid polymers, include, but are not limited to, polymaleic acid homopolymers, polyacrylic acid copolymers, and maleic anhydride/olefin copolymers.

Polymaleic acid (C₄H₂O₃)x or hydrolyzed polymaleic anhydride or cis-2-butenedioic acid homopolymer, has the structural formula:

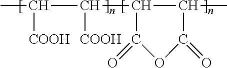

where n and m are any integer. Examples of polymaleic acid homopolymers, copolymers, and/or terpolymers (and salts thereof) which may be used are particularly preferred are those with a molecular weight of about 0 and about 5000, more preferably between about 200 and about 2000 (can you confirm these MWs). Commercially available polymaleic acid homopolymers include the Belclene 200 series of maleic acid homopolymers from BWA™ Water Additives, 979 Lakeside Parkway, Suite 925 Tucker, GA 30084, USA and Aquatreat AR-801 available from AkzoNobel. The polymaleic acid homopolymers, copolymers, and/or terpolymers may be present in an end-use composition from about 0.01 wt. % to about 30 wt. %.

An end-use composition can include polyacrylic acid polymers, copolymers, and/or terpolymers. Poly acrylic acids have the following structural formula:

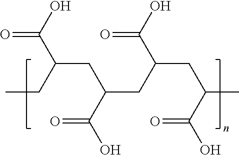

where n is any integer. Examples of suitable polyacrylic acid polymers, copolymers, and/or terpolymers, include but are not limited to, the polymers, copolymers, and/or terpolymers of polyacrylic acids, (C₃H₄O₂), or 2-Propenoic acid, acrylic acid, polyacrylic acid, propenoic acid.

In a preferred embodiment of an end-use composition comprising a polymer, particularly suitable acrylic acid polymers, copolymers, and/or terpolymers have a molecular weight between about 100 and about 10,000, in a preferred embodiment between about 500 and about 7000, in an even more preferred embodiment between about 1000 and about 5000, and in a most preferred embodiment between about 1500 and about 3500. Examples of polyacrylic acid polymers, copolymers, and/or terpolymers (or salts thereof) which may be used include, but are not limited to, Acusol 448 and Acusol 425 from The Dow Chemical Company, Wilmington Delaware, USA. In particular embodiments it may be desirable to have acrylic acid polymers (and salts thereof) with molecular weights greater than about 10,000. Examples, include but are not limited to, Acusol 929 (10,000 MW) and Acumer 1510 (60,000 MW) both also available from Dow Chemical, AQUATREAT AR-6 (100,000 MW) from AkzoNobel Strawinskylaan 2555 1077 ZZ Amsterdam Postbus 75730 1070 AS Amsterdam. The polyacrylic acid polymer, copolymer, and/or terpolymer may be present in the compositions from about may be present in an end-use composition from about 0.01 wt. % to about 30 wt. %.

Maleic anhydride/olefin copolymers are copolymers of polymaleic anhydrides and olefins. Maleic anhydride (C₂H₂(CO)₂O has the following structure:

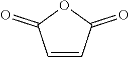

A part of the maleic anhydride can be replaced by maleimide, N-alkyl(C₁₋₄) maleimides, N-phenyl-maleimide, fumaric acid, itaconic acid, citraconic acid, aconitic acid, crotonic acid, cinnamic 10 acid, alkyl (C₁₋₁₈) esters of the foregoing acids, cycloalkyl(C₃₋₈) esters of the foregoing acids, sulfated castor oil, or the like.

At least 95 wt % of the maleic anhydride polymers, copolymers, or terpolymers have a number average molecular weight of in the range between about 700 and about 20,000, preferably between about 1000 and about 100,000.

A variety of linear and branched chain alpha-olefins can be used for the purposes of this disclosure. Particularly useful alpha-olefins are dienes containing 4 to 18 carbon atoms, such as butadiene, chloroprene, isoprene, and 2-methyl-1,5-hexadiene; 1-alkenes containing 4 to 8 carbon atoms, preferably C₄₋₁₀, such as isobutylene, 1-butene, 1-hexene, 1-octene, and the like.

In a preferred embodiment, particularly suitable maleic anhydride/olefin copolymers have a molecular weight between about 1000 and about 50,000, in a preferred embodiment between about 5000 and about 20,000, and in a most preferred embodiment between about 7500 and about 12,500. Examples of maleic anhydride/olefin copolymers which may be used include, but are not limited to, Acusol 460N from The Dow Chemical Company, Wilmington Delaware, USA. The maleic anhydride/olefin copolymer may be present in an end-use composition from about 0.01 wt. % to about 30 wt. %.

### Sanitizers/Anti-Microbial Agents

Some end-use compositions can optionally include a sanitizing agent. Sanitizing agents also known as antimicrobial agents are chemical compositions that can be used in a solid functional material to prevent microbial contamination and deterioration of material systems, surfaces, etc. Generally, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds.

It should also be understood that active oxygen compounds, such as those discussed above in the bleaching agents section, may also act as antimicrobial agents, and can even provide sanitizing activity. In fact, in some embodiments, the ability of the active oxygen compound to act as an antimicrobial agent reduces the need for additional antimicrobial agents within the composition. For example, percarbonate compositions have been demonstrated to provide excellent antimicrobial action. Nonetheless, some embodiments incorporate additional antimicrobial agents.

The given antimicrobial agent, depending on chemical composition and concentration, may simply limit further proliferation of numbers of the microbe or may destroy all or a portion of the microbial population. The terms “microbes” and “microorganisms” typically refer primarily to bacteria, virus, yeast, spores, and fungus microorganisms. In use, the antimicrobial agents are typically formed into a solid functional material that when diluted and dispensed, optionally, for example, using an aqueous stream forms an aqueous disinfectant or sanitizer composition that can be contacted with a variety of surfaces resulting in prevention of growth or the killing of a portion of the microbial population. A three log reduction of the microbial population results in a sanitizer composition. The antimicrobial agent can be encapsulated, for example, to improve its stability.

Some examples of common antimicrobial agents include phenolic antimicrobials such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary antimicrobial agents such as benzalkonium chloride, didecyldimethyl ammonium chloride, choline diiodochloride, tetramethyl phosphonium tribromide. Other antimicrobial compositions such as hexahydro-1,3,5-tris(2-hydroxyethyl)-s- -triazine, dithiocarbamates such as sodium dimethyldithiocarbamate, and a variety of other materials are known in the art for their antimicrobial properties.

In embodiments of end-use compositions which are phosphate-free, and/or sulfate-free, and also include an anti-microbial agent, the anti-microbial is selected to meet those requirements. Embodiments of end-use compositions which include only GRAS ingredients, may exclude or omit anti-microbial agents described in this section.

In some embodiments, an end-use composition comprises, an antimicrobial component in the range of up to about 10% by wt. of the composition, in some embodiments in the range of up to about 5 wt. %, or in some embodiments, in the range of about 0.01 to about 3 wt. %, or in the range of 0.05 to 1% by wt. of the composition.

### Additional Surfactants

The end-use compositions can include one or more surfactants in addition to the capped block copolymers. These can be referred to as a secondary surfactant, additional surfactant and/or co-surfactant. Preferably, a co-surfactant is in solid form. The end-use compositions can include, but are not limited to, detergent compositions, warewash compositions, laundry compositions, rinse aids, hard surface cleaning compositions, and paper/pulp processing compositions. Surfactants that can be included as a co-surfactant in the solidified surfactant compositions and/or as a surfactant in an end-use composition, include, nonionic surfactants, semi polar nonionic surfactants, anionic surfactants, cationic surfactants, amphoteric surfactants, zwitterionic surfactants, and mixtures or combinations of the same.

### Nonionic Surfactants

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful nonionic surfactants include:

Block polyoxypropylene-polyoxyethylene polymeric compounds based upon propylene glycol, ethylene glycol, glycerol, trimethylolpropane, and ethylenediamine as the initiator reactive hydrogen compound. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-flinctional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Neodol™ manufactured by Shell Chemical Co. and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade name Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Examples of nonionic low foaming surfactants include:

Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. The hydrophobic portion of the molecule weighs from about 2,100 to about 6,700 with the central hydrophile including 10% by weight to 80% by weight of the final molecule.

Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959 to Brown et al. and represented by the formula

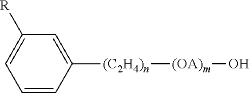

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆O)ₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the some end-use compositions correspond to the formula: P[(C₃H₆O)ₙ (C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-Cis ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or ——(C₂H₄O)ₓH, where x is in the range of from 1 to 3.

A useful class of non-ionic surfactants include the class defined as alkoxylated amines or, most particularly, alcohol alkoxylated/aminated/alkoxylated surfactants. These non-ionic surfactants may be at least in part represented by the general formulac: R²⁰——(PO)ₛN——(EO)ₜH, R²⁰——(PO)_{S}N——(EO)ₜH(EO)ₜH, and R²⁰——N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰——(PO)ᵥ——N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Preferred nonionic surfactants for the end-use compositions include alcohol alkoxylates, EO/PO block copolymers, alkylphenol alkoxylates, and the like.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

### Semi-Polar Nonionic Surfactants

The semi-polar type of nonionic surface active agents are another class of nonionic surfactant useful in some end-use compositions. Generally, semi-polar nonionics are high foamers and foam stabilizers, which can limit their application in CIP systems. The semi-polar nonionic surfactants include the amine oxides, phosphine oxides, sulfoxides and their alkoxylated derivatives.

Amine oxides are tertiary amine oxides corresponding to the general formula:

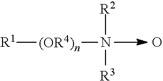

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R2 and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Useful semi-polar nonionic surfactants also include the water soluble phosphine oxides having the following structure:

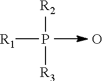

wherein the arrow is a conventional representation of a semi-polar bond; and, R¹ is an alkyl, alkenyl or hydroxyalkyl moiety ranging from 10 to about 24 carbon atoms in chain length; and, R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.

Semi-polar nonionic surfactants useful herein also include the water soluble sulfoxide compounds which have the structure:

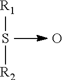

wherein the arrow is a conventional representation of a semi-polar bond; and, R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Suitable nonionic surfactants suitable for use with the compositions include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)s(PO)4) and Dehypon LS-36 (R-(EO)3(PO)6); and capped alcohol alkoxylates, such as Plurafac LF221 and Tegoten EC_{11;} mixtures thereof, or the like.

Anionic surfactants

The end-use compositions can also comprise one or more anionic surfactants. Anionic surfactants are surface active substances which are categorized as anionics because the charge on the hydrophobe is negative; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility. As those skilled in the art understand, anionics are excellent detersive surfactants and are therefore favored additions to heavy duty detergent compositions.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and the aromatic sulfonates with or without substituents.

Anionic carboxylate surfactants suitable for use in the present compositions include carboxylic acids (and salts), such as alkanoic acids (and alkanoates), ester carboxylic acids (e.g. alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a C₈ to C₂₂ alkyl group or

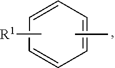

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

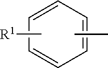

and R¹ is a C₆-C₁₂ alkyl group. In still yet other embodiments, R¹ is a Co alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂-13 alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g. the product Sandopan® DTC, a C₁₃ alkyl polyethoxy (7) carboxylic acid.

### Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y—— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

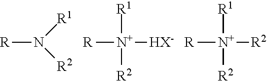

in which, R represents an alkyl chain, R′, R″, and R′″ may be either alkyl chains or aryl groups or hydrogen and X represents an anion. The amine salts and quaternary ammonium compounds are preferred for practical use due to their high degree of water solubility.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

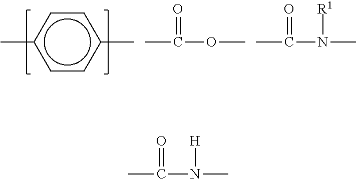

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens.

Y is can be a group including, but not limited to:

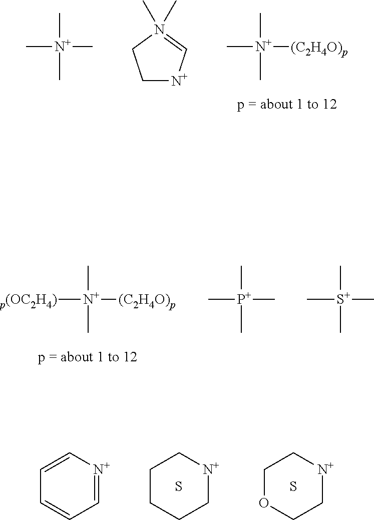

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

### Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having potential application generally have the general formula:

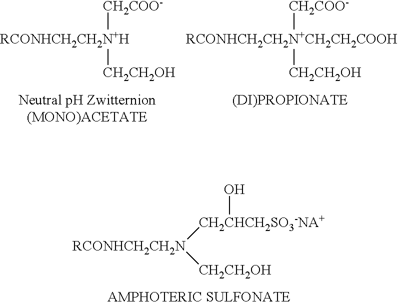

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R=C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having potential application include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH-CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated by reference in their entirety.

### Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

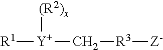

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

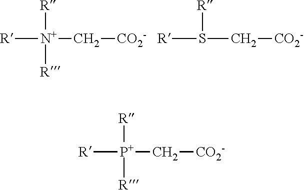

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines potentially useful include those compounds having the formula (R(R¹)₂ N⁺ R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated in their entirety.

### Methods of Manufacturing End-Use Compositions

The end-use compositions can be prepared by any suitable method of preparation depending on the type of product to be prepared (i.e., liquid, solid, concentrated or use solution). For example, liquid compositions can typically be made by forming the ingredients in an aqueous liquid or aqueous liquid solvent system. Such systems are typically made by dissolving or suspending the active ingredients in water or in compatible solvent and then diluting the product to an appropriate concentration, either to form a concentrate or a use solution thereof. Gelled compositions can be made similarly by dissolving or suspending the active ingredients in a compatible aqueous, aqueous liquid or mixed aqueous organic system including a gelling agent at an appropriate concentration.

In embodiments where the end-use compositions are prepared as solid compositions, the solid compositions can include, but are not limited to granular and pelletized solid compositions, powders, solid block compositions, cast solid block compositions, extruded solid block composition, pressed solid compositions, and others.

Solid particulate end-use compositions can be made by merely blending the dry solid ingredients in appropriate ratios or agglomerating the materials in appropriate agglomeration systems. Pelletized materials can be manufactured by compressing the solid granular or agglomerated materials in appropriate pelletizing equipment to result in appropriately sized pelletized materials. Solid block and cast solid block materials can be made by introducing into a container either a prehardened block of material or a castable liquid that hardens into a solid block within a container. Preferred containers include disposable plastic containers or water-soluble film containers. Other suitable packaging for the composition includes flexible bags, packets, shrink wrap, and water-soluble film such as polyvinyl alcohol.

The solid end-use compositions may be formed using a batch or continuous mixing system. In an exemplary embodiment, a single-or twin-screw extruder is used to combine and mix one or more components at high shear to form a homogeneous mixture. In some embodiments, the processing temperature is at or below the melting temperature of the components. The processed mixture may be dispensed from the mixer by forming, casting or other suitable means, whereupon the end-use composition hardens to a solid form. The structure of the matrix may be characterized according to its hardness, melting point, material distribution, crystal structure, and other like properties according to known methods in the art.

Generally, a solid end-use composition is substantially homogeneous with regard to the distribution of ingredients throughout its mass and is dimensionally stable.

In an extrusion process, the liquid and solid components are introduced into final mixing system and are continuously mixed until the components form a substantially homogeneous semi-solid mixture in which the components are distributed throughout its mass. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

In a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

In a pressed solid process, a flowable solid, such as granular solids or other particle solids are combined under pressure. In a pressed solid process, flowable solids of the compositions are placed into a form (e.g., a mold or container). The method can include gently pressing the flowable solid in the form to produce the solid end-use composition. Pressure may be applied by a block machine or a turntable press, or the like. Pressure may be applied at about 1 to about 3000 psi, about 5 to about 2500 psi, or about 10 psi to about 2000 psi. As used herein, the term “psi” or “pounds per square inch” refers to the actual pressure applied to the flowable solid being pressed and does not refer to the gauge or hydraulic pressure measured at a point in the apparatus doing the pressing. The method can include a curing step to produce the solid composition. As referred to herein, an uncured composition including the flowable solid is compressed to provide sufficient surface contact between particles making up the flowable solid that the uncured composition will solidify into a stable solid composition. A sufficient quantity of particles (e.g., granules) in contact with one another provides binding of particles to one another effective for making a stable solid composition. Inclusion of an optional curing step may include allowing the pressed solid to solidify for a period of time, such as a few hours, or about 1 day (or longer). In additional aspects, the methods could include vibrating the flowable solid in the form or mold, such as the methods disclosed in U.S. Pat. No. 8,889,048, which is herein incorporated by reference in its entirety.

The use of pressed solids provide numerous benefits over conventional solid block or tablet compositions requiring high pressure in a tablet press, or casting requiring the melting of a composition consuming significant amounts of energy, and/or by extrusion requiring expensive equipment and advanced technical know-how. Pressed solids overcome such various limitations of other solid formulations for which there is a need for making solid compositions. Moreover, pressed solid compositions retain its shape under conditions in which the composition may be stored or handled.

By the term “solid”, it is meant that the hardened composition will not flow and will substantially retain its shape under moderate stress or pressure or mere gravity. A solid may be in various forms such as a powder, a flake, a granule, a pellet, a tablet, a lozenge, a puck, a briquette, a brick, a solid block, a unit dose, or another solid form known to those of skill in the art. The degree of hardness of the solid cast composition and/or a pressed solid composition may range from that of a fused solid product which is relatively dense and hard, for example, like concrete, to a consistency characterized as being a hardened paste. In addition, the term “solid” refers to the state of the end-use composition under the expected conditions of storage and use of the solid composition. In general, it is expected that the end-use composition will remain in solid form when exposed to temperatures of up to approximately 37.8° C. and particularly up to approximately 48.9° C.

The resulting solid composition may take forms including, but not limited to: a cast solid product; an extruded, molded or formed solid pellet, block, tablet, powder, granule, flake; pressed solid; or the formed solid can thereafter be ground or formed into a powder, granule, or flake. In an exemplary embodiment, extruded pellet materials formed by the solidification matrix have a weight of between approximately 50 grams and approximately 250 grams, extruded solids formed by the composition have a weight of approximately 100 grams or greater, and solid block detergents formed by the composition have a mass of between approximately 1 and approximately 10 kilograms. The solid compositions provide for a stabilized source of functional materials. In some embodiments, the solid composition may be dissolved, for example, in an aqueous or other medium, to create a concentrated and/or use solution. The solution may be directed to a storage reservoir for later use and/or dilution, or may be applied directly to a point of use.

The following patents disclose various combinations of solidification, binding and/or hardening agents that can be utilized in the solid compositions. The detailed descriptions from the following U.S. patents are incorporated herein by reference: U.S. Pat. Nos. 7,153,820; 7,094,746; 7,087,569; 7,037,886; 6,831,054; 6,730,653; 6,660,707; 6,653,266; 6,583,094; 6,410,495; 6,258,765; 6,177,392; 6,156,715; 5,858,299; 5,316,688; 5,234,615; 5,198,198; 5,078,301; 4,595,520; 4,680,134; RE32,763; and RE32818.

Preferred Embodiments

The present disclosure is further defined by the following numbered embodiments:

1. A surfactant comprising: a multiarm block copolymer comprising a polyfunctional moiety and at least 2 alkoxylated arms each of which is selected from the group consisting of: —(PO)_{Y}(EO)_{X}, —(EO)_{X}(PO)_{Y}, —(EO)_{X}(PO)_{Y}(EO)_{X}, and —(PO)_{Y}(EO)_{X}(PO)_{Y}; wherein X is about 1 to about 100, and Y is about 1 to about 100; wherein each of the alkxoylated arms comprises a terminus and at least one of the alkoxylated arms is capped with a hydrophobic group at the terminus.

2. The surfactant of embodiment 1, wherein the polyfunctional moiety has 2, 3,

4, 5, or 6 alkoxylated arms.

3. The surfactant of embodiment 2, wherein the polyfunctional moiety has 2 alkoxylated arms that are capped.

4. The surfactant of embodiment 2, wherein the polyfunctional moiety has 3 alkoxylated arms that are capped.

5. The surfactant of embodiment 2, wherein the polyfunctional moiety has 4 alkoxylated arms that are capped.

6. The surfactant of embodiment 2, wherein the polyfunctional moiety has 5 alkoxylated arms that are capped.

7. The surfactant of any one of embodiments 1-6, wherein the each of the alkoxylated arms comprises

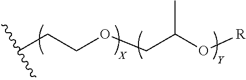

wherein X is about 1 to about 50; wherein Y is about 1 to about 50; and wherein R is the hydrophobic group.

8. The surfactant of any one of embodiments 1-7, wherein the multiarm block copolymer comprises the following alkoxylated arms

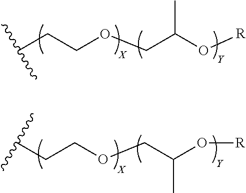

wherein X is about 1 to about 50; wherein Y is about 1 to about 50; and wherein R is the hydrophobic group.

9. The surfactant of any one of embodiments 1, 2, or 4-7, wherein the multiarm block copolymer comprises the following alkoxylated arms

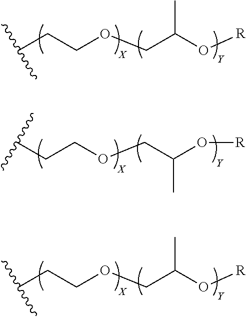

wherein X is about 1 to about 50; wherein Y is about 1 to about 50; and wherein R is the hydrophobic group.

10. The surfactant of any one of embodiments 1, 2, 5-7, wherein the multiarm block copolymer comprises the following alkoxylated arms

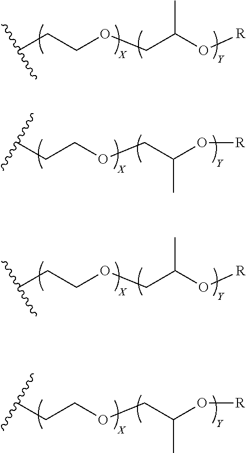

wherein X is about 1 to about 50; wherein Y is about 1 to about 50; and wherein R is the hydrophobic group.

11. The surfactant of any one of embodiments 1-10, wherein the hydrophobic group comprises a benzyl group, a substituted silyl group, or a combination thereof.

12. The surfactant of embodiment 11, wherein the substituted silyl group is

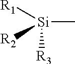

where each of R¹, R², and R³ comprises an alkyl group, a phenol group, or tert-butyl.

13. The surfactant of any one of embodiments 1-12, wherein hydrophobic group comprises TMS, TES, TIPS, TBS, TBDPS, or a combination thereof.

14. The surfactant of any one of embodiments 1-13, wherein the block copolymer has a molecular weight (Mₙ−number average mw) greater than about 200 and less than about 25,000.

15. The surfactant of any one of embodiments 1-14, wherein the block copolymer has a polyfunctional moiety of polyol, ethylene diamine, or diethylenetriamine.

16. The surfactant of embodiment 15, wherein the polyol has a carbon number of C₁-C₁₈.

17. The surfactant of embodiment 16, wherein the polyol has a carbon number of C₁₀-C₁₈.

18. The surfactant of any one of embodiments 1-17, wherein the block copolymer the EO groups are between about 20% and about 60% of the alkoxylated arms, and wherein the PO groups are between about 40% and about 80% of the alkoxyalated arms.

19. The surfactant of embodiment 18, wherein the block copolymer the EO groups are between about 30% and about 50% of the alkoxylated arms, and wherein the PO groups are between about 50% and about 70% of the alkoxyalated arms.

20. The surfactant of any one of embodiments 1-19, wherein the surfactant has a surface tension of less than about 35 dynes/cm when measured under ambient conditions.

21. The surfactant of embodiment 20, wherein the surfactant has a surface tension of less than about 25 dynes/cm when measured under ambient conditions.

22. The surfactant of any one of embodiments 1-21, wherein the surfactant provides defoaming and antifoaming properties.

23. The surfactant of any one of the embodiments 1-22, wherein the surfactant is capped with a benzyl group; and wherein the surfactant has increased viscoelasticity and improved thermal stability.

24. A cleaning, rinsing, softening, or decoking composition comprising:
the surfactant of any one of embodiments 1-23.

25. The composition of embodiment 24, wherein the composition is a machine warewash composition and further comprises an alkalinity source and water.

26. The composition of embodiment 25, wherein the alkalinity source is in an amount between about 50 wt. % and about 95 wt. %, the surfactant is in a concentration of between about 1 wt. % and about 35 wt. %, and the water is in a concentration between about 0.01 wt. % and about 15 wt. %.

27. The composition of embodiment 26, further comprising one or more additional functional ingredients.

28. The composition of any one of embodiments 24-27, wherein the composition is effective against proteinaceous soils.

29. The composition of embodiment 24, wherein the composition is a paper/pulp processing composition and further comprises a softening composition and a processing aid.

30. The composition of embodiment 29, wherein the softening composition is in an amount between about 10 wt. % and about 80 wt. %, the surfactant is in a concentration of between about 0.01 wt. % and about 20 wt. %, and the processing aid is in a concentration of between about 0.01 wt. % and about 10 wt. %.

31. The composition of embodiment 30, further comprising one or more additional functional ingredients and/or a solidification aid.

33. The composition of embodiment 24, wherein the composition is a decoking composition and each arm of the surfactant is capped.

34. The composition of embodiment 33, wherein the arms are capped with a benzyl group.

35. A method of synthesizing the surfactant of any one of embodiments 1-23, comprising: capping a block copolymer with a hydrophobic capping chemistry, wherein the hydrophobic capping chemistry comprises a benzyl group and/or a silyl group.

36. The method of embodiment 35, wherein the method comprises the step of deprotonating the block copolymer then reacting the block copolymer with a benzyl salt to form the surfactant.

37. The method of embodiment 36, wherein the benzyl salt is in an amount of between about 3 to about 5 molar equivalents to the block copolymer.

38. The method of embodiment 35, wherein the method comprises silylation and comprises a step of mixing a silyl salt with the block copolymer in a molar ratio of between about 3 and about 20 molar equivalents of silyl to block copolymer.

39. The method of embodiment 38, further comprising mixing TEA with the silyl salt and block copolymer; wherein the TEA is added in amount of between about 5 and about 15 molar equivalents to the block copolymer.

40. The method of embodiment 38 or 39, wherein the silyl salt comprises a salt of TMS, TES, TIPS, TBS, or TBDPS.

41. The method of embodiment 40, wherein the silyl salt comprises TMS or TIPS.

### EXAMPLES

Embodiments of the capped block copolymers and compositions containing them are further defined in the following non-limiting Examples. It should be understood that these

Examples, while indicating one or more preferred embodiments, are given by way of illustration only and are non-limiting. From the above discussion and these Examples, one skilled in the art can ascertain the essential characteristics of the disclosed compositions, and without departing from the spirit and scope thereof, can make various changes and modifications of the embodiments disclosed herein to adapt it to various usages and conditions. Thus, various modifications of the embodiments, in addition to those shown and described herein, will be apparent to those skilled in the art from the foregoing description. Such modifications are also intended to fall within the scope of the appended claims.

Materials used:
ACUSOL ® 448 (A448): A polyacrylic/polymaleic acid copolymer
NALCO® DVS3C_{008:} a phosphinic acid, sodium salt
PLURONIC® 25R^{2:} a commercially available reverse block copolymer
TETRONIC® 90R^{4:} a commercially available reverse block copolymer
Commercially available sodium hydroxide, sodium aluminate, xylenesulfonic acid sodium salt, glycerol carbonate, and disodium carbonate.

### Example 1

Example capped block copolymers were synthesized and evaluated against a high-foaming detergent to assess the ability anti-foam properties and defoaming properties. The example capped block copolymers were synthesized according to Table 2.

TABLE 2

| | | Molar | | |
|---|---|---|---|---|
| | | ratio | | |
| | | of block | | Inerts |
| | | copolymer to | Actives | (carrier |
| Sample | | capping | esti- | and |
| ID | Description | chemistry | mated | salt) |
| 8815- | Silylated Tetronic 90R4 | 1.0/4.0 | 42% | Water and |
| 03-IVb | capped with TMS at | | | NaCl |
| | room temp. | | | |
| 8815- | Silylated Tetronic 90R4 | 1.0/4.0 | 52% | Water and |
| 03-IVc | with TMS at 80° C. | | | NaCl |
| 8815- | Tetronic 90R4 capped | 1.0/4.0 | 50% | Water and |
| 03-XI | with TIPS at room temp. | | | NaCl |
| 8815- | Tetronic 90R4 capped | 1.0/4.0 | 55% | Water and |
| 03-XII | with TIPS at 80° C. | | | NaCl |
| 8815- | Tretronic 90R4 capped | 1.0/3.5 | 97.18% | NaCl |
| 07-IX | with benzyl | | | |
| 8815- | Tetronic 90R4 capped | 1.0/3.2 | 97.20% | NaCl |
| 07-XI | with benzyl | | | |

A test was performed with blanks consisting of a centrifuge tube filled with 25 ml of distilled water at 50° C. and one drop of a high foaming soap. The blanks were then shaken horizontally immediately for 30 seconds. The initial foam volume was recorded in Table 3 as “Foaming.” A drop of each example capped block copolymer was added to the distilled water and shook horizontally in a centrifuge tube for 30 seconds. Into the same centrifuge tube, another drop of the high foaming soap was added, shaken vigorously, and recorded in Table 3 as “Antifoaming” as this demonstrated the prevention of foaming. The mixture was allowed to rest for about 1 minute to assess any difference in the foam, this was recorded as “defoaming” as it demonstrated the block copolymers affect at breaking the foam to reduce the foam volume formed initially.

TABLE 3

| | | Antifoaming | Defoaming |
|---|---|---|---|
| | | (vs. | (of |
| | Foaming | Pantastic), | Pantastic), |
| Description | (mL) | 50° C. | 50° C. |
| DI water | 0.0 | 0.0% | 0.0% |
| Ethylenediamine EO/PO | 5.0 | 0.0% | 0.0% |
| Silicone-silica | 0.0 | 100.0% | 100.0% |
| Tetronic 90R4-TMS (RT) | 12.0 | 0.0% | 0.0% |
| Tetronic 90R4-TMS (80° C.) | 8.5 | 0.0% | 60.0% |
| Tetronic 90R4-TIPS (RT) | 3.5 | 78.7% | 77.8% |
| Tetronic 90R4-TIPS (80° C.) | 5.0 | 86.0% | 74.4% |
| Tetronic 90R4-benzyl | 5.0 | 40% | 66.7% |
| Polyglycerol oleate ester | <0.5 | 80% | 88.9% |

Based on the results of Table 3, three exemplary formulas were created as shown in Table 4.

TABLE 4

| TMS-capped | (52.18%) | g | t-Amyl | DI | SCS* g | Surfactant |
|---|---|---|---|---|---|---|
| Tetronic | | | alcohol g | water g | | Actives |
| 90R4 | 30.23% | | 13.44% | 0.00% | 56.33% | 15.77% |
| formula | | | | | | |
| TIPS-capped | (~60%) | g | t-Amyl | DI | SCS g | Actives |
| Tetronic | | | alcohol g | water g | | |
| 90R4 | 36.50% | | 19.71% | 0.00% | 43.80% | 21.90% |
| formula | | | | | | |
| Bn-capped | (neat) | g | t-Amyl | DI | SCS | Actives |
| Tetronic | | | alcohol g | water g | (45%) g | |

| | | | | | |
|---|---|---|---|---|---|
| 90R4 | 25.00% | 20.00% | 25.00% | 30.00% | 24.34% |

### Example 2

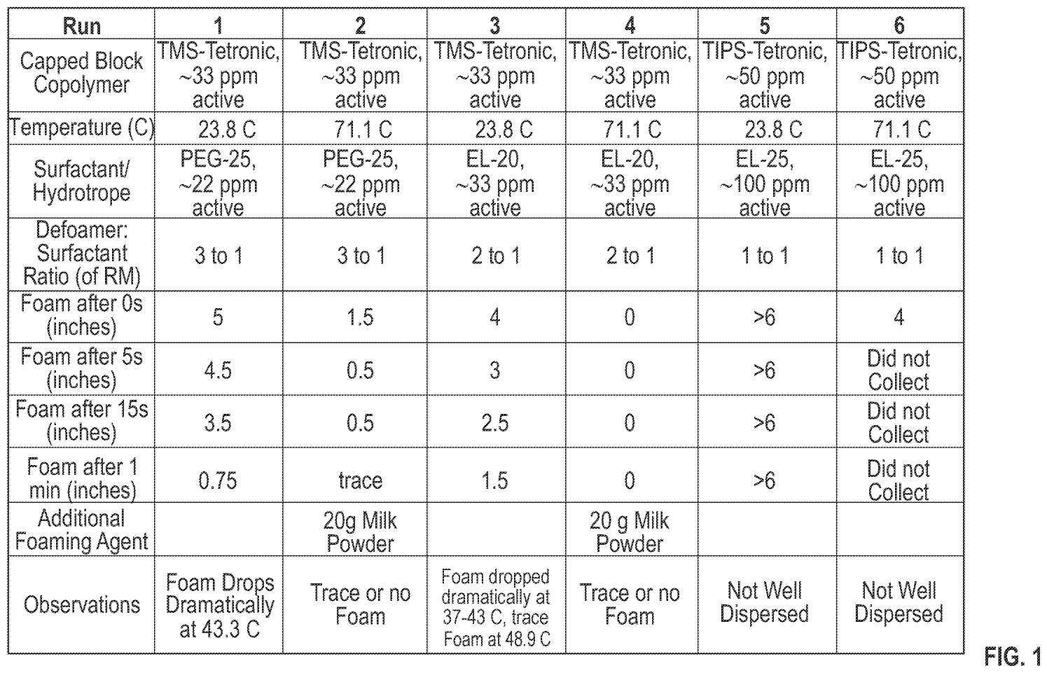

Exemplary capped block copolymers Tetronic 90R4 capped with TMS (TMS-Tetronic 90R4) and Tetronic 90R4 capped with TIPS (TIPS-Tetronic 90R4), were again evaluated and results were recorded as seen in the table at FIG. 1. The foaming test evaluation revealed the example capped block copolymers were very difficult to disperse in water due to the silylated caps being silicophilic (dislike both water and hydrocarbons), especially in low active use dilutions. The PEG modified castor oils were found to reasonably help in dispersion of TMS-Tetronic 90R4, but not TIPS-Tetronic 90R4. The results of the defoaming test evaluation also showed the potential of the silylated Tetronic 90R4 molecules as a superior defoamer, especially over an uncapped Tetronic 90R4 molecule.

### Example 3

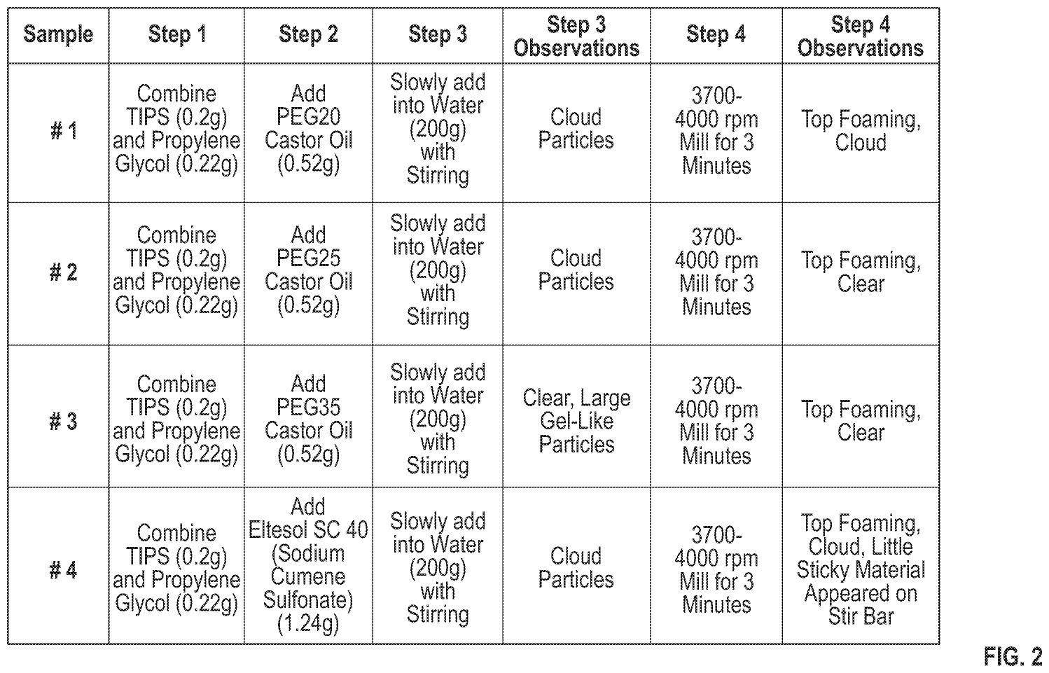

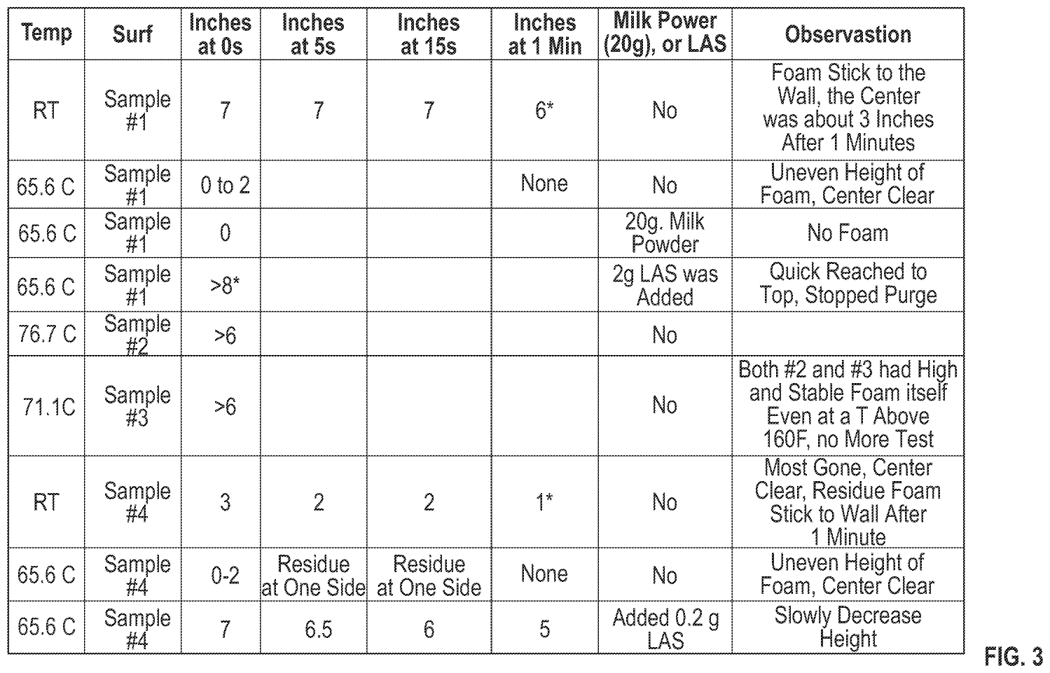

Based on the findings of Example 2, additional samples of the capped block copolymers were created according to the table in FIG. 2. These four samples were evaluated by a foaming test with 3000ml of water, wherein the effective concentration of TIPS-Tetronic 90R4 was between 33 ppm to 66 ppm in testing. The results of the four sample capped block copolymers were analyzed for the height of the foam in inches immediately (0 seconds), at 5 seconds, 15 seconds, and 1 minute, as seen in the table shown in FIG. 3. From these results, it is clear to see that TIPS-Tetronic 90R4 dispersed better than that in Example 2 and defoamed powdered milk generated foam better than the uncapped Tetronic 90R4.

### Example 4

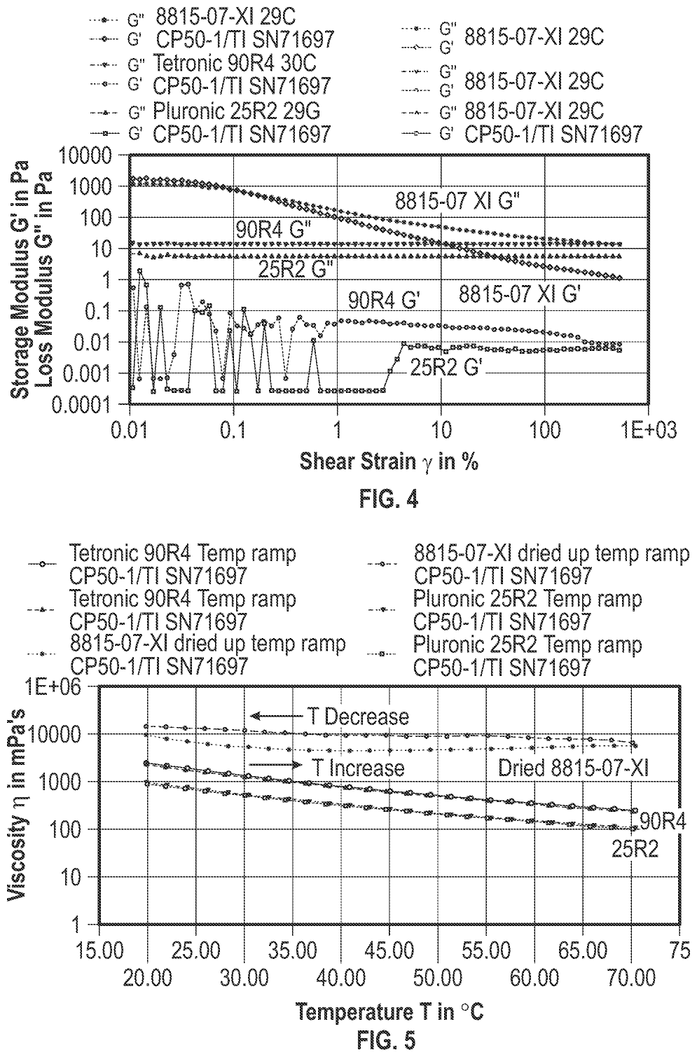

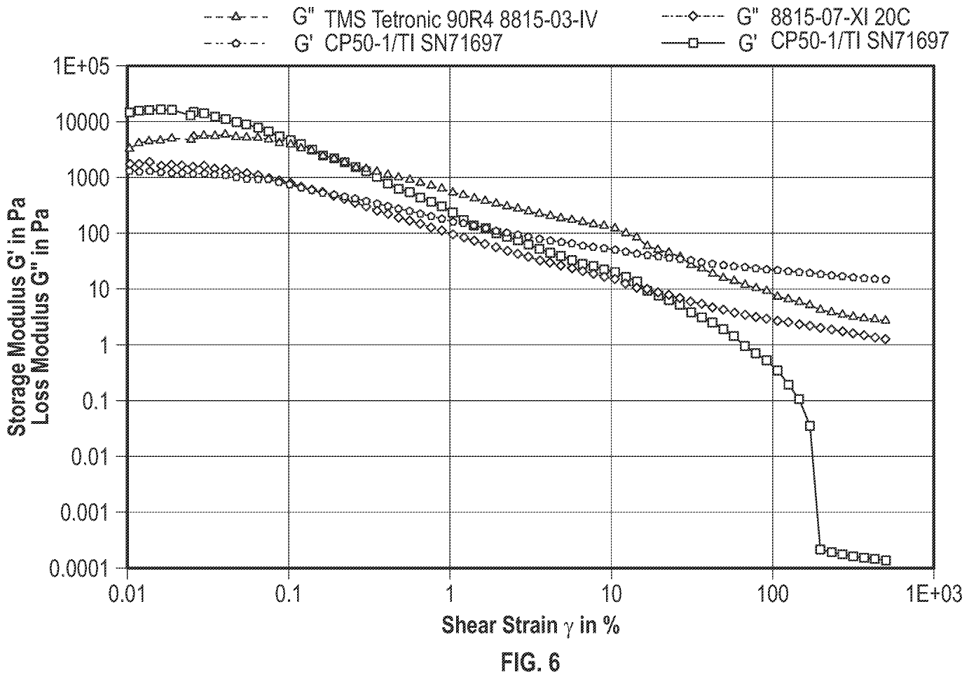

The rheological properties of an example benzyl-capped block copolymer (“Bn-Tetronic 90R4 formula described in Table 4, were further evaluated and compared against a neat uncapped Tetronic 90R4 and Pluronic 25R2 at the temperature range of 20-70° C. FIGS. 4-6 compare the compositions. FIG. 5 show the three compared compositions along the temperature range from 20° C. to 70° C. to 20° C. The Bn-Tetronic 90R4 was dried in an oven before repeating the temperature comparison, the results of which are visualized in FIG. 5. FIG. 4 illustrates the comparison of the compositions by shear strain ramp from 0.01% to 500% at 20° C.

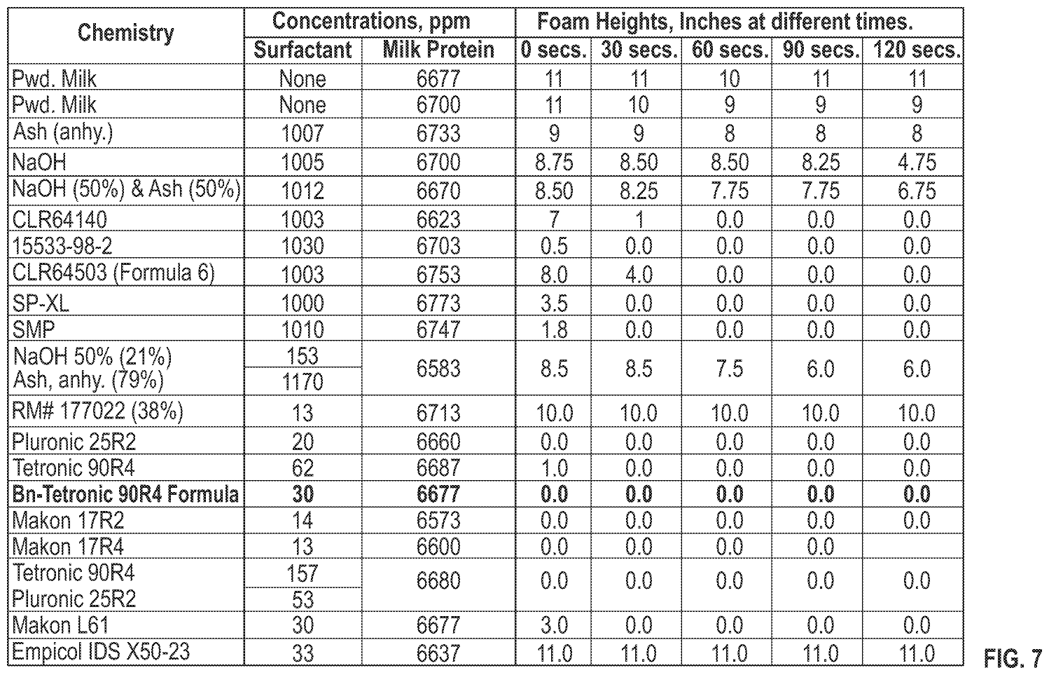

FIG. 5 confirms the unique high elastic modulus (G′) of the Bn-Tetronic 90R4, which is absent from either the neat uncapped Tetronic 90R4 and Pluronic 25R2. This result indicates a strong inter-molecular interaction, or a type of associative effect between a benzyl end group from those of neighboring molecules, which resist deformation and may provide a persistence important for anti-foaming and defoaming performance. Thus, we found that fully uncapped arms provided less elasticity and the best results were found when the capping was at a ratio of from about 2:1 to 4:1, most preferably about 3:1 capped to uncapped arms. Similarly, the example silyl-capped block copolymer TMS-Tetronic 90R4 was compared to the example benzyl-capped block copolymer Bn-Tetronic 90R4 through a sheer strain from 0.01% to 500%, as illustrated in FIG. 6. The graph in FIG. 6 further indicates that the silyl-capped Tetronic 90R4 high elastic modulus (G′) is increased 10-fold compared to the benzyl-capped Tetronic.

### Example 5

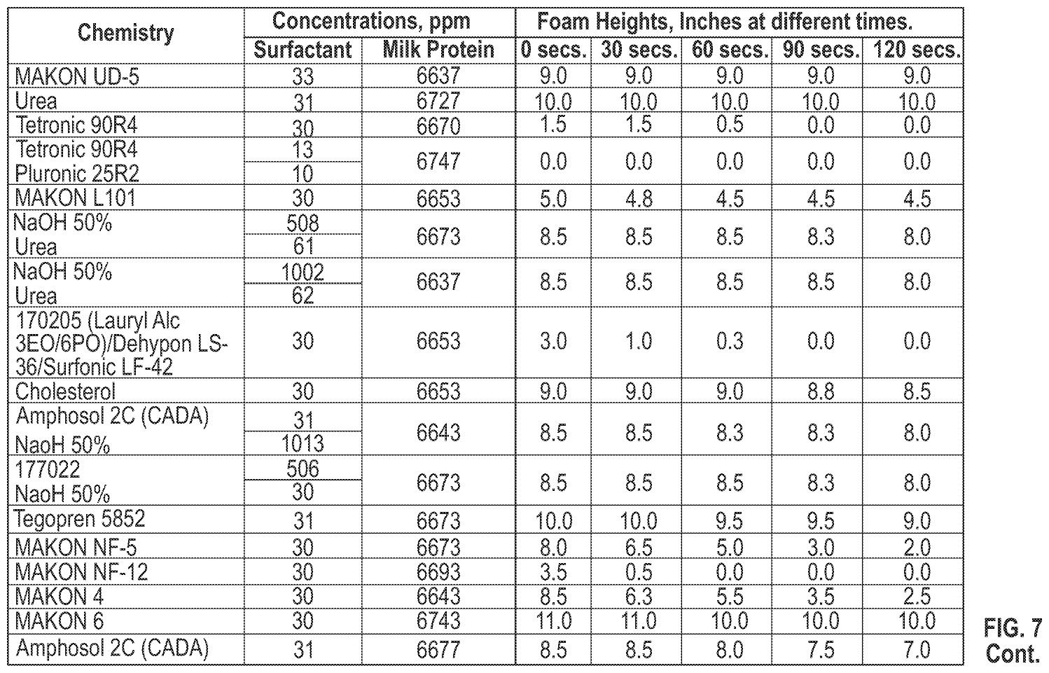

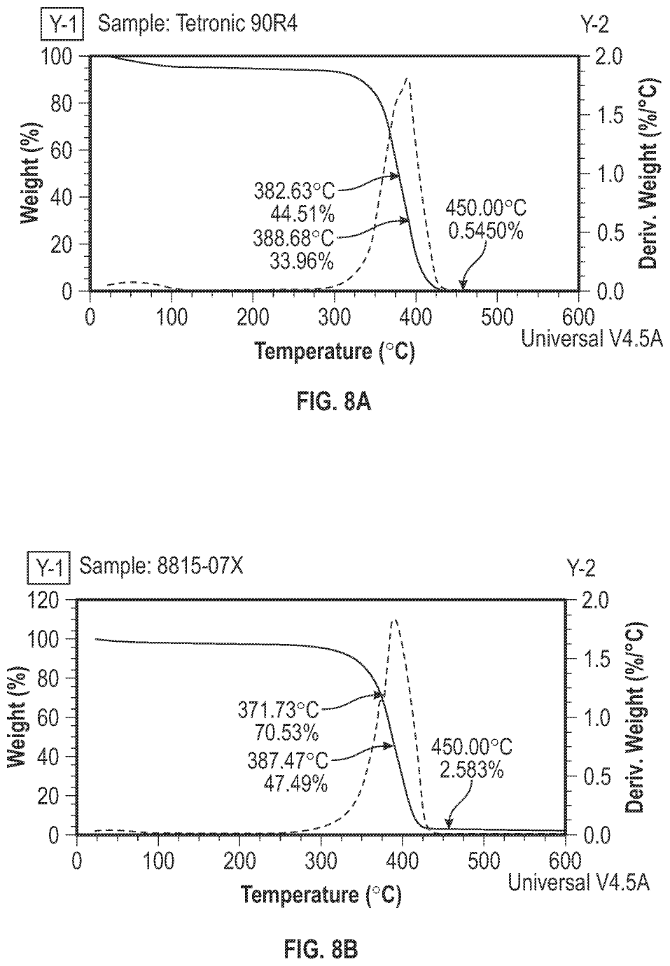

Powdered milk was evaluated by comparing the foam behavior alone and under different alkalinity and detergent conditions. The powdered milk was at 6700 ppm and combined with detergents at 1000 ppm. The powdered milk and powdered milk/detergent solutions were evaluated at 140 to 146° F. and 6 psi. The resulting foam was measured for height in inches at 30 second time increments, as illustrated in the Table at FIG. 7. The example capped block copolymer, Bn-Tetronic 90R4, was also evaluated under the same circumstances and is bolded in the table shown in FIG. 7.

As seen by the results of the evaluation, the powdered milk proteins rehydrate and retain natural conformation to stabilize foam. The caustic detergents, when they are at 1000 ppm, partially denature the powdered milk protein to a higher degree than the ash, causing lower and more unstable foam. This is understandable from an ionic strength standpoint, as hydroxide anion has a higher activity coefficient than carbonate anion, and NaOH has a much lower molecular weight than sodium carbonate. Thus, the data provided in this example confirms that per weight, caustic is a much stronger denaturant than ash.

The data further confirms that, as far as defoaming free protein, reverse block copolymers (where PO blocks are at the terminus) are more effective than “regular” block copolymers (where EO blocks are at the terminus). The results of the evaluation indicate that thee defoaming properties of the surfactants are dictated by the balance of PO vs. EO, and that reverse block copolymers of 10-20% EO (thus 90-80% PO) are the most effective defoamers of protein soils. Although, the results also indicate that the number of arms of block copolymers do not appear to be an important factor for defoaming of free protein. For example, Pluronic 25R2, a linear (2-armed) reverse block copolymer with 20% EO and 80% PO, is a significantly better defoamer of free protein than Tetronic 90R4, a four-armed reverse block copolymer of 40% EO and 60% PO.

### Example 6

A further example was evaluated to assess the suitability of the surfactants in certain industrial uses. For example, some processes including but not limited to a decoking process require defoaming in oleophase at high temperature; thus there is a requirement that the surfactants can withstand higher temperatures (up to about 400°° C.). For this example, we tested benzyl capped surfactants and obtained GTC (thermal conductivity analysis) data which provided stability of decomposition at increased temperatures.

An additional testing with the Tetronic 90R4 was conducted on refinery delayed coker. Specifically, TGA (Thermogravimetric) Analysis was conducted at 10° C. per minute from room temperature to 600° C. with N2 flowing at 60 mL/minute.

Tetronic 90R4 was used as a starting material in order to test benzyl capped Chemistry A. The data reflected that benzyl capped Tetronic 90R4 experienced improved thermal stability.

Both sets of data indicated that benzyl capping the arms increased the temperature

stability of the block copolymers andrevealed that defoaming in oleophase a high temperature can withstand higher temperatures of about 400° C.

From the foregoing, it can be seen that the present disclosure accomplishes at least all of the stated objectives.

The inventions being thus described, it will be obvious that the same may be varied in many ways. Such variations are not to be regarded as a departure from the spirit and scope of the inventions and all such modifications are intended to be included within the scope of the following claims.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A surfactant comprising:
a multiarm block copolymer comprising a polyfunctional moiety and at least 2 alkoxylated arms each of which is selected from the group consisting of: —(PO)_{Y}(EO)_{X}, —(EO)_{X}(PO)_{Y}, —(EO)_{X}(PO)_{Y}(EO)_{X}, and —(PO)_{Y}(EO)_{X}(PO)_{Y}; wherein X is about 1 to about 100, and Y is about 1 to about 100;
wherein each of the alkxoylated arms comprises a terminus and at least one of the alkoxylated arms is capped with a hydrophobic group at the terminus.

2. The surfactant of claim 1, wherein the polyfunctional moiety has 2, 3, 4, 5, or 6 alkoxylated arms.

3. The surfactant of claim 2, wherein the polyfunctional moiety has 2, 3, or 4 alkoxylated arms that are capped.

4. The surfactant of claim 1, wherein the each of the alkoxylated arms comprises 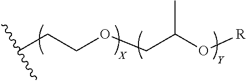
wherein X is about 1 to about 50; wherein Y is about 1 to about 50; and wherein R is the hydrophobic group.

5. The surfactant of claim 1, wherein the multiarm block copolymer comprises the following alkoxylated arms 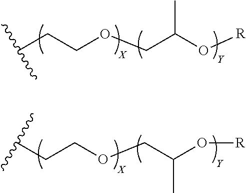
wherein X is about 1 to about 50; wherein Y is about 1 to about 50; and wherein R is the hydrophobic group.

6. The surfactant of claim 1, wherein the multiarm block copolymer comprises the following alkoxylated arms 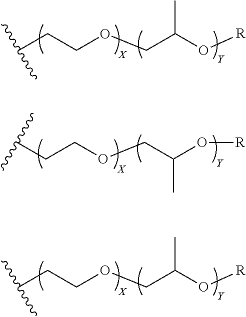
wherein X is about 1 to about 50; wherein Y is about 1 to about 50; and wherein R is the hydrophobic group.

7. The surfactant of claim 1, wherein the multiarm block copolymer comprises the following alkoxylated arms 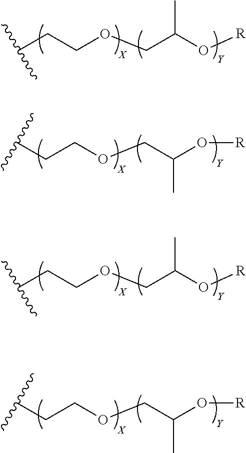
wherein X is about 1 to about 50; wherein Y is about 1 to about 50; and wherein R is the hydrophobic group.

8. The surfactant of claim 2, wherein the hydrophobic group comprises a benzyl group, a substituted silyl group, or a combination thereof.

9. The surfactant of claim 8, wherein the substituted silyl group is 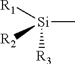
where each of R₁, R₂, and R₃ comprises an alkyl group, a phenol group, or tert-butyl.

10. The surfactant of claim 9, wherein hydrophobic group comprises TMS, TES, TIPS, TBS, TBDPS, or a combination thereof.

11. The surfactant of claim 1, wherein the block copolymer has a molecular weight (Mₙ−number average mw) greater than about 200 and less than about 25,000; and
a polyfunctional moiety of polyol, ethylene diamine, or diethylenetriamine.

12. The surfactant of claim 1, wherein the block copolymer the EO groups are between about 20% and about 60% of the alkoxylated arms, and wherein the PO groups are between about 40% and about 80% of the alkoxyalated arms.

13. The surfactant of claim 1, wherein the surfactant has a surface tension of less than about 35 dynes/cm when measured under ambient conditions.

14. The surfactant of claim 1, wherein the surfactant provides defoaming and antifoaming properties.

15. The surfactant of claim 8, wherein the surfactant is capped with a benzyl group; and
wherein the surfactant has increased viscoelasticity and improved thermal stability.

16. A cleaning, rinsing, softening, or decoking composition comprising:
the surfactant of claim 1.

17. The composition of claim 16, wherein the composition is a machine warewash composition and further comprises an alkalinity source and water; wherein the alkalinity source is in an amount between about 50 wt. % and about 95 wt. %, the surfactant is in a concentration of between about 1 wt. % and about 35 wt. %, and the water is in a concentration between about 0.01 wt. % and about 15 wt. %.

18. The composition of claim 16, wherein the composition is a paper/pulp processing composition and further comprises a softening composition and a processing aid; wherein the softening composition is in an amount between about 10 wt. % and about 80 wt. %, the surfactant is in a concentration of between about 0.01 wt. % and about 20 wt. %, and the processing aid is in a concentration of between about 0.01 wt. % and about 10 wt. %.

19. The composition of claim 16, wherein the composition is a decoking composition and each arm of the surfactant is capped with a benzyl group.

20. A method of synthesizing the surfactant of claim 1, comprising:
capping a block copolymer with a hydrophobic capping chemistry, wherein the hydrophobic capping chemistry comprises a benzyl group and/or a silyl group.
